(19) United States
(12) Patent Application Publication
(10) Pub. No.: US 2019/0335197 A1
(43) Pub. Date: Oct. 31, 2019

(54) IMAGE ENCODING/DECODING METHOD AND DEVICE, AND RECORDING MEDIUM HAVING BITSTREAM STORED THEREON

(71) Applicants: ELECTRONICS AND TELECOMMUNICATIONS RESEARCH INSTITUTE, Daejeon (KR); UNIVERSITY-INDUSTRY COOPERATION GROUP OF KYUNG HEE UNIVERSITY, Yongin-si (KR)

(72) Inventors: Jung Won KANG, Daejeon (KR); Hyun Suk KO, Daejeon (KR); Sung Chang LIM, Daejeon (KR); Jin Ho LEE, Daejeon (KR); Ha Hyun LEE, Seoul (KR); Dong San JUN, Daejeon (KR); Seung Hyun CHO, Daejeon (KR); Hui Yong KIM, Daejeon (KR); Jin Soo CHOI, Daejeon (KR); Gwang Hoon PARK, Seongnam-si (KR); Tae Hyun KIM, Hwaseong-si (KR); Dae Young LEE, Ansan-si (KR)

(73) Assignees: ELECTRONICS AND TELECOMMUNICATIONS RESEARCH INSTITUTE, Daejeon (KR); UNIVERSITY-INDUSTRY COOPERATION GROUP OF KYUNG HEE UNIVERSITY, Yongin-si (KR)

(21) Appl. No.: 16/349,637

(22) PCT Filed: Nov. 22, 2017
(86) PCT No.: PCT/KR2017/013331

§ 371 Date: May 14, 2019

(30) Foreign Application Priority Data
Nov. 22, 2016 (KR) 10-2016-0155813

(51) Int. Cl. H04N 19/527; H04N 19/573; H04N 19/577; H04N 19/105; H04N 19/137; H04N 19/172

(52) U.S. Cl. CPC H04N 19/527; H04N 19/573; H04N 19/172; H04N 19/105; H04N 19/137; H04N 19/577

(57) ABSTRACT

The present invention relates to a method for encoding an image and method for decoding an image. The method for decoding an image includes: predicting global motion information; and performing inter prediction based on the predicted global motion information, wherein the global motion information is represented by any one of a two-dimensional vector, a geometric transform matrix, a rotation angle, and a magnification ratio.

### TECHNICAL FIELD

The present invention relates to a method and apparatus for encoding/decoding an image, and a recording medium for storing a bitstream. More particularly, the present invention relates to a method and apparatus for encoding/decoding an image using a method of predicting global motion information.

### BACKGROUND ART

Recently, demands for high-resolution and high-quality images such as high definition (HD) images and ultra high definition (UHD) images, have increased in various application fields. However, higher resolution and quality images have increased amounts of image data in comparison with conventional image data. Therefore, when transmitting image data by using a medium such as conventional wired and wireless broadband networks, or when storing image data by using a conventional storage medium, costs of transmitting and storing increase. In order to solve these problems occurring with an increase in resolution and quality of image data, high-efficiency image compression techniques are required.

Video compression methods includes various methods, including: an inter-prediction method of predicting a pixel value included in a current picture from a previous or subsequent picture of the current picture; an intra-prediction method of predicting a pixel value included in a current picture by using pixel information in the current picture; an entropy encoding method of assigning a short code to a value with a high occurrence frequency and assigning a long code to a value with a low occurrence frequency; etc. Image data may be effectively compressed by using such image compression technology, and may be transmitted or stored.

When the entire image includes motions having the same tendency due to camera work, inter-prediction may be performed by using global motion information.

A large number of bits in a bitstream are used for global motion information depending on accuracy and a representation range. Also, when all global motions between reference frames are represented, more bits are used, and thus encoding efficiency is decreased.

### DISCLOSURE

### Technical Problem

An object of the present invention is to provide a method and apparatus for encoding/decoding an image with enhanced compression efficiency.

Also, the present invention can provide a method of predicting global motion information in order to enhance encoding/decoding efficiency of an image.

### Technical Solution

According to the present invention, there is provided a method for decoding an image, the method including: predicting global motion information; and

performing inter prediction based on the predicted global motion information, wherein the global motion information is represented by any one of a two-dimensional vector, a geometric transform matrix, a rotation angle, and a magnification ratio.

In the method for decoding an image, at the predicting of the global motion information, the global motion information may be predicted based on global motion information for at least one neighbor reference picture in a reference picture list and a POC (Picture Of Count) interval of the at least one neighbor reference picture and a current picture.

In the method for decoding an image, at the predicting of the global motion information, the global motion information may be predicted based on multiple pieces of local motion information.

In the method for decoding an image, at the predicting of the global motion information, the global motion information may be predicted using an average of the multiple pieces of local motion information.

In the method for decoding an image, at the predicting of the global motion information, the global motion information may be predicted interpolating global motion information of at least one neighbor reference picture.

In the method for decoding an image, at the predicting of the global motion information, when the global motion information is represented by the geometric transform matrix, the global motion information may be predicted based on matrix multiplication of global motion information of at least one neighbor reference picture.

In the method for decoding an image, at the predicting of the global motion information, when the global motion information is represented by the geometric transform matrix, the global motion information may be predicted using a unit matrix.

In the method for decoding an image, global motion information for a chroma component may be predicted based on global motion information for a luma component.

According to the present invention, there is provided a method for decoding an image, the method including: determining a global motion prediction mode based on global motion prediction mode information; generating global motion information based on the determined global motion prediction mode; and performing inter prediction based on the generated global motion information, wherein the global motion prediction mode includes a prediction skip mode, a residual transmission mode, and a residual non-transmission.

In the method for decoding an image, at the generating of the global motion information, when the global motion prediction mode is the prediction skip mode, the global motion information may be obtained from a bitstream, and when the global motion prediction mode is the residual transmission mode, a global motion may be generated using residual global motion information obtained from the bitstream and predicted global motion information, and when the global motion prediction mode is the residual non-transmission mode, the global motion may be generated using the predicted global motion information.

According to the present invention, there is provided a method for encoding an image, the method including: predicting global motion information; and

performing inter prediction based on the predicted global motion information, wherein the global motion information is represented by any one of a two-dimensional vector, a geometric transform matrix, a rotation angle, and a magnification ratio.

In the method for encoding an image, at the predicting of the global motion information, the global motion information may be predicted based on global motion information for at least one neighbor reference picture in a reference picture list and a POC (Picture Of Count) interval of the at least one neighbor reference picture and a current picture.

In the method for encoding an image, at the predicting of the global motion information, the global motion information may be predicted based on multiple pieces of local motion information.

In the method for encoding an image, at the predicting of the global motion information, the global motion information may be predicted using an average of the multiple pieces of local motion information.

In the method for encoding an image, at the predicting of the global motion information, the global motion information may be predicted interpolating global motion information of at least one neighbor reference picture.

In the method for encoding an image, at the predicting of the global motion information, when the global motion information is represented by the geometric transform matrix, the global motion information may be predicted based on matrix multiplication of global motion information of at least one neighbor reference picture.

In the method for encoding an image, at the predicting of the global motion information, when the global motion information is represented by the geometric transform matrix, the global motion information may be predicted using a unit matrix.

In the method for encoding an image, in global motion information for a multi-channel image, global motion information for one channel may be predicted based on global motion information of another channel.

In the method for encoding an image, global motion information for a chroma component may be predicted based on global motion information for a luma component.

According to the present invention, there is provided a method for encoding an image, the method including: determining a global motion prediction mode; generating global motion information based on the determined global motion prediction mode; performing inter prediction based on the generated global motion information; and encoding global motion prediction mode information indicating the determined global motion prediction mode, wherein the global motion prediction mode includes a prediction skip mode, a residual transmission mode, and a residual non-transmission.

According to the present invention, a recording medium stores a bitstream formed by a method for encoding an image, the method including: predicting global motion information; and performing inter prediction based on the predicted global motion information, wherein the global motion information is represented by any one of a two-dimensional vector, a geometric transform matrix, a rotation angle, and a magnification ratio.

### Advantageous Effects

According to the present invention, a method and apparatus for encoding/decoding an image can be provided with enhanced compression efficiency.

Also, according to the present invention, a method and apparatus for encoding/decoding an image using inter prediction with enhanced compression efficiency can be provided.

Also, according to the present invention, a recording medium storing a bitstream generated by a method or apparatus for encoding an image according to the present invention can be provided.

Also, according to the present invention, encoding efficiency can be enhanced by generating global motion information through prediction without transmitting global motion information.

### DESCRIPTION OF DRAWINGS

FIG. 1 is a block diagram showing a configuration of an encoding apparatus according to an embodiment to which the present invention is applied.

FIG. 2 is a block diagram showing a configuration of a decoding apparatus according to an embodiment to which the present invention is applied.

FIG. 3 is a view showing a division structure of an image when encoding and decoding the image.

FIG. 4 is a view showing an example process of inter-prediction.

FIG. 5 (FIGS. 5a to 5d) is a view for illustrating an example of generating a global motion.

FIG. 6 is a view for illustrating an example method of representing a global motion of an image.

FIG. 7 is a flowchart for illustrating an encoding method and a decoding method of using global motion information.

FIG. 8 is a view showing a transform example when each point of an image moves in parallel.

FIG. 9 is a view showing an image transform example transformed through a size modification.

FIG. 10 is a view showing an image transform example transformed through a rotation modification.

FIG. 11 is a view showing an example of an affine transform.

FIG. 12 is a view showing an example of a projective transform.

FIG. 13 is a view for illustrating an example of image encoding and decoding methods using an image geometric transform.

FIG. 14 is a view for illustrating an example of an encoding apparatus using an image geometric transform.

FIG. 15 is a view for illustrating an example of representing a global motion that requires a large number of bits.

FIG. 16 is a view illustrating an example of a relation between reference frames.

FIG. 17 is a view illustrating an example of motion of an image over time and a graph showing this.

FIG. 18 is a view illustrating an example of a global motion prediction method for linear parallel shift.

FIG. 19 is a view illustrating an example of a global motion prediction method for linear rotation shift.

FIG. 20 is a view illustrating a global motion prediction method for linear scaling.

FIGS. 21 and 22 are views illustrating a method of predicting a global motion by parallel shift from local motions represented by two-dimensional vectors.

FIGS. 23, 24, and 25 are views respectively illustrating methods of predicting a global motion by rotation shift, zooming in, and zooming out.

FIG. 26 is a view illustrating an example of grouping areas having similar local motions and representing a global motion for each area.

FIG. 27 is a view illustrating an example of a method of predicting global motion information represented by a two-dimensional vector.

FIG. 28 is a view illustrating examples of a geometric transform matrix.

FIG. 29 is a view illustrating an example of interpolation for each parameter of motion information.

FIG. 30 (FIGS. 30a and 30b) is a view illustrating examples of an encoding apparatus and a decoding apparatus using reconstructed global motion information in global motion prediction, being limited to a current reference picture buffer.

FIGS. 31 and 32 are views illustrating examples of an encoding apparatus and a decoding apparatus continually accumulating and using global motion information included in a reconstructed reference frame for global motion prediction.

FIGS. 33 and 34 are views illustrating examples of an encoding apparatus and a decoding apparatus accumulating reconstructed global motion information in units of a GOP to be used in global motion prediction.

FIG. 35 is a view illustrating an example of a global motion prediction method by matrix multiplication.

FIG. 36 is a view illustrating an example of a method of predicting global motion information by performing multiplication of a geometric transform matrix.

FIG. 37 is a view illustrating an example of a method of predicting global motion information by performing multiplication of multiple geometric transform matrices.

FIG. 38 is a view illustrating an example of a method of predicting global motion information by performing multiplication of a geometric transform matrix and a geometric transform inverse matrix.

FIG. 39 is a view illustrating an example where a global motion cannot be predicted directly by geometric transform matrix multiplication.

FIG. 40 is a view illustrating an example of a method of predicting global motion information using linear prediction.

FIG. 41 is a view illustrating an example of a method of predicting global motion information using a unit matrix.

FIG. 42 is a view illustrating an example of, as the case where all global motion prediction methods of Method 1, Method 2, Method 3, and Method 4 are applied, a method of selecting an optimum prediction method and transmitting information on which prediction method is used to a decoder.

FIG. 43 is a view illustrating an example of, with a particular criterion, an encoding apparatus and a decoding apparatus selecting and using the same prediction method without transmitting and receiving additional information.

FIG. 44 is a view illustrating an example of a global motion prediction method for a chroma image.

FIG. 45 is a view illustrating a method using only predicted global motion information without transmitting additional global motion information.

FIG. 46 is a view illustrating a method transmitting a difference between predicted global motion information and original global motion information so as to reduce the amount of information to be transmitted.

FIGS. 47 and 48 are views illustrating examples of a syntax of HEVC (High Efficiency Video Coding) to which a method of transmitting and receiving a global motion residual signal is applied.

FIG. 49 (FIGS. 49a and 49b) is a view illustrating examples of encoding and decoding methods that select and use a method capable of obtaining optimum encoding efficiency among a method intactly using predicted global motion information without transmitting additional global motion information, a method transmitting residual global motion information, and a method transmitting original global motion information.

FIGS. 50, 51, and 58 are views illustrating examples where a method of selectively applying a method of transmitting and receiving a global motion signal of the present invention is applied to a syntax of HEVC (High Efficiency Video Coding).

FIGS. 52, 53, and 59 are views illustrating examples where a method of selectively applying a global motion prediction method is applied to a syntax of HEVC (High Efficiency Video Coding).

FIG. 54 is a flowchart illustrating a method for decoding an image according to an embodiment of the present invention.

FIG. 55 is a flowchart illustrating a method for decoding an image according to an embodiment of the present invention.

FIG. 56 is a flowchart illustrating a method for encoding an image according to an embodiment of the present invention.

FIG. 57 is a flowchart illustrating a method for encoding an image according to an embodiment of the present invention.

### MODE FOR INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to what the claims claim.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of items or any one of a plurality of terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than the corresponding element are not excluded, but additional elements may be included in embodiments of the present invention or the scope of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

In addition, hereinafter, an image may mean a picture configuring a video, or may mean the video itself. For example, “encoding or decoding or both of an image” may mean “encoding or decoding or both of a video”, and may mean “encoding or decoding or both of one image among images of a video.” Here, a picture and the image may have the same meaning.

Description of Terms

Encoder: means an apparatus performing encoding.

Decoder: means an apparatus performing decoding

Block: is an M×N array of a sample. Herein, M and N mean positive integers, and the block may mean a sample array of a two-dimensional form. The block may refer to a unit. A current block my mean an encoding target block that becomes a target when encoding, or a decoding target block that becomes a target when decoding. In addition, the current block may be at least one of an encode block, a prediction block, a residual block, and a transform block.

Sample: is a basic unit constituting a block. It may be expressed as a value from 0 to 2^{Bd}−1 according to a bit depth (Bd). In the present invention, the sample may be used as a meaning of a pixel.

Unit: refers to an encoding and decoding unit. When encoding and decoding an image, the unit may be a region generated by partitioning a single image. In addition, the unit may mean a subdivided unit when a single image is partitioned into subdivided units during encoding or decoding. When encoding and decoding an image, a predetermined process for each unit may be performed. A single unit may be partitioned into sub-units that have sizes smaller than the size of the unit. Depending on functions, the unit may mean a block, a macroblock, a coding tree unit, a code tree block, a coding unit, a coding block), a prediction unit, a prediction block, a residual unit), a residual block, a transform unit, a transform block, etc. In addition, in order to distinguish a unit from a block, the unit may include a luma component block, a chroma component block associated with the luma component block, and a syntax element of each color component block. The unit may have various sizes and forms, and particularly, the form of the unit may be a two-dimensional geometrical figure such as a rectangular shape, a square shape, a trapezoid shape, a triangular shape, a pentagonal shape, etc. In addition, unit information may include at least one of a unit type indicating the coding unit, the prediction unit, the transform unit, etc., and a unit size, a unit depth, a sequence of encoding and decoding of a unit, etc.

Coding Tree Unit: is configured with a single coding tree block of a luma component Y, and two coding tree blocks related to chroma components Cb and Cr. In addition, it may mean that including the blocks and a syntax element of each block. Each coding tree unit may be partitioned by using at least one of a quad-tree partitioning method and a binary-tree partitioning method to configure a lower unit such as coding unit, prediction unit, transform unit, etc. It may be used as a term for designating a pixel block that becomes a process unit when encoding/decoding an image as an input image.

Coding Tree Block: may be used as a term for designating any one of a Y coding tree block, Cb coding tree block, and Cr coding tree block.

Neighbor Block: means a block adjacent to a current block. The block adjacent to the current block may mean a block that comes into contact with a boundary of the current block, or a block positioned within a predetermined distance from the current block. The neighbor block may mean a block adjacent to a vertex of the current block. Herein, the block adjacent to the vertex of the current block may mean a block vertically adjacent to a neighbor block that is horizontally adjacent to the current block, or a block horizontally adjacent to a neighbor block that is vertically adjacent to the current block.

Reconstructed Neighbor block: means a neighbor block adjacent to a current block and which has been already spatially/temporally encoded or decoded. Herein, the reconstructed neighbor block may mean a reconstructed neighbor unit. A reconstructed spatial neighbor block may be a block within a current picture and which has been already reconstructed through encoding or decoding or both. A reconstructed temporal neighbor block is a block at the same position as the current block of the current picture within a reference picture, or a neighbor block thereof.

Unit Depth: means a partitioned degree of a unit. In a tree structure, a root node may be the highest node, and a leaf node may be the lowest node. In addition, when a unit is expressed as a tree structure, a level in which a unit is present may mean a unit depth.

Bitstream: means a bitstream including encoding image information.

Parameter Set: corresponds to header information among a configuration within a bitstream. At least one of a video parameter set, a sequence parameter set, a picture parameter set, and an adaptation parameter set may be included in a parameter set. In addition, a parameter set may include a slice header, and tile header information.

Parsing: may mean determination of a value of a syntax element by performing entropy decoding, or may mean the entropy decoding itself.

Symbol: may mean at least one of a syntax element, a coding parameter, and a transform coefficient value of an encoding/decoding target unit. In addition, the symbol may mean an entropy encoding target or an entropy decoding result.

Prediction Unit: means a basic unit when performing prediction such as inter-prediction, intra-prediction, inter-compensation, intra-compensation, and motion compensation. A single prediction unit may be partitioned into a plurality of partitions with a small size, or may be partitioned into a lower prediction unit.

Prediction Unit Partition: means a form obtained by partitioning a prediction unit.

Reference Picture List: means a list including one or more reference pictures used for inter-picture prediction or motion compensation. LC (List Combined), L0 (List 0), L1 (List 1), L2 (List 2), L3 (List 3) and the like are types of reference picture lists. One or more reference picture lists may be used for inter-picture prediction.

Inter-picture prediction Indicator: may mean an inter-picture prediction direction (uni-directional prediction, bi-directional prediction, and the like) of a current block. Alternatively, the inter-picture prediction indicator may mean the number of reference pictures used to generate a prediction block of a current block. Further alternatively, the inter-picture prediction indicator may mean the number of prediction blocks used to perform inter-picture prediction or motion compensation with respect to a current block.

Reference Picture Index: means an index indicating a specific reference picture in a reference picture list.

Reference Picture: may mean a picture to which a specific block refers for inter-picture prediction or motion compensation.

Motion Vector: is a two-dimensional vector used for inter-picture prediction or motion compensation and may mean an offset between a reference picture and an encoding/decoding target picture. For example, (mvX, mvY) may represent a motion vector, mvX may represent a horizontal component, and mvY may represent a vertical component.

Motion Vector Candidate: may mean a block that becomes a prediction candidate when predicting a motion vector, or a motion vector of the block. A motion vector candidate may be listed in a motion vector candidate list.

Motion Vector Candidate List: may mean a list of motion vector candidates.

Motion Vector Candidate Index: means an indicator indicating a motion vector candidate in a motion vector candidate list. It is also referred to as an index of a motion vector predictor.

Motion Information: may mean information including a motion vector, a reference picture index, an inter-picture prediction indicator, and at least any one among reference picture list information, a reference picture, a motion vector candidate, a motion vector candidate index, a merge candidate, and a merge index.

Merge Candidate List: means a list composed of merge candidates.

Merge Candidate: means a spatial merge candidate, a temporal merge candidate, a combined merge candidate, a combined bi-prediction merge candidate, a zero merge candidate, or the like. The merge candidate may have an inter-picture prediction indicator, a reference picture index for each list, and motion information such as a motion vector.

Merge Index: means information indicating a merge candidate within a merge candidate list. The merge index may indicate a block used to derive a merge candidate, among reconstructed blocks spatially and/or temporally adjacent to a current block. The merge index may indicate at least one item in the motion information possessed by a merge candidate.

Transform Unit: means a basic unit when performing encoding/decoding such as transform, inverse-transform, quantization, dequantization, transform coefficient encoding/decoding of a residual signal. A single transform unit may be partitioned into a plurality of transform units having a small size.

Scaling: means a process of multiplying a transform coefficient level by a factor. A transform coefficient may be generated by scaling a transform coefficient level. The scaling also may be referred to as dequantization.

Quantization Parameter: may mean a value used when generating a transform coefficient level of a transform coefficient during quantization. The quantization parameter also may mean a value used when generating a transform coefficient by scaling a transform coefficient level during dequantization. The quantization parameter may be a value mapped on a quantization step size.

Delta Quantization Parameter: means a difference value between a predicted quantization parameter and a quantization parameter of an encoding/decoding target unit.

Scan: means a method of sequencing coefficients within a block or a matrix. For example, changing a two-dimensional matrix of coefficients into a one-dimensional matrix may be referred to as scanning, and changing a one-dimensional matrix of coefficients into a two-dimensional matrix may be referred to as scanning or inverse scanning.

Transform Coefficient: may mean a coefficient value generated after transform is performed in an encoder. It may mean a coefficient value generated after at least one of entropy decoding and dequantization is performed in a decoder. A quantized level obtained by quantizing a transform coefficient or a residual signal, or a quantized transform coefficient level also may fall within the meaning of the transform coefficient.

Quantized Level: means a value generated by quantizing a transform coefficient or a residual signal in an encoder. Alternatively, the quantized level may mean a value that is a dequantization target to undergo dequantization in a decoder. Similarly, a quantized transform coefficient level that is a result of transform and quantization also may fall within the meaning of the quantized level.

Non-zero Transform Coefficient: means a transform coefficient having a value other than zero, or a transform coefficient level having a value other than zero.

Quantization Matrix: means a matrix used in a quantization process or a dequantization process performed to improve subjective or objective image quality. The quantization matrix also may be referred to as a scaling list.

Quantization Matrix Coefficient: means each element within a quantization matrix. The quantization matrix coefficient also may be referred to as a matrix coefficient.

Default Matrix: means a predetermined quantization matrix preliminarily defined in an encoder or a decoder.

Non-default Matrix: means a quantization matrix that is not preliminarily defined in an encoder or a decoder but is signaled by a user.

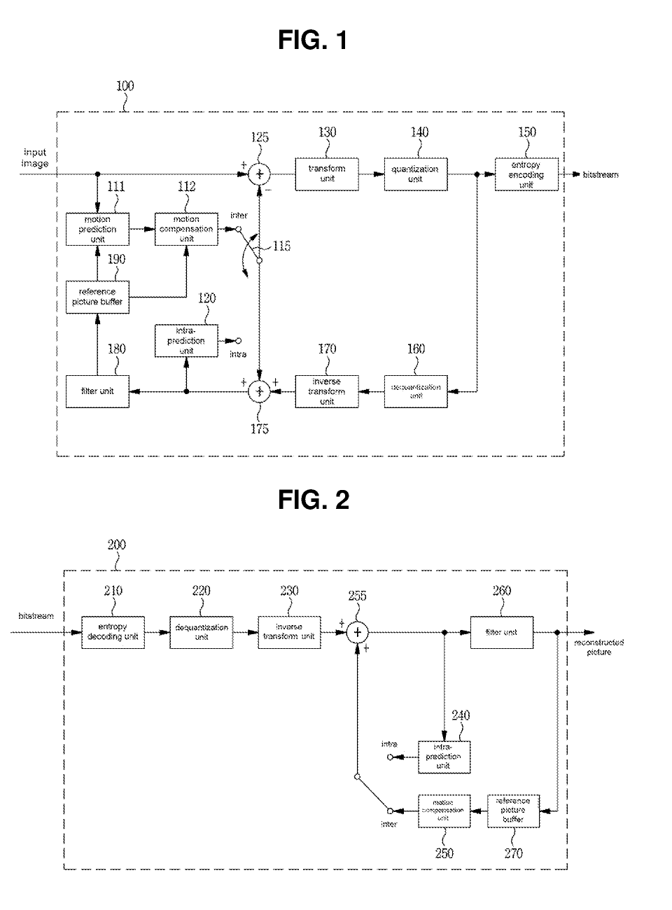

FIG. 1 is a block diagram showing a configuration of an encoding apparatus according to an embodiment to which the present invention is applied.

An encoding apparatus 100 may be an encoder, a video encoding apparatus, or an image encoding apparatus. A video may include at least one image. The encoding apparatus 100 may sequentially encode at least one image.

Referring to FIG. 1, the encoding apparatus 100 may include a motion prediction unit 111, a motion compensation unit 112, an intra-prediction unit 120, a switch 115, a subtractor 125, a transform unit 130, a quantization unit 140, an entropy encoding unit 150, a dequantization unit 160, a inverse-transform unit 170, an adder 175, a filter unit 180, and a reference picture buffer 190.

The encoding apparatus 100 may perform encoding of an input image by using an intra mode or an inter mode or both. In addition, encoding apparatus 100 may generate a bitstream through encoding the input image, and output the generated bitstream. The generated bitstream may be stored in a computer readable recording medium, or may be streamed through a wired/wireless transmission medium. When an intra mode is used as a prediction mode, the switch 115 may be switched to an intra. Alternatively, when an inter mode is used as a prediction mode, the switch 115 may be switched to an inter mode. Herein, the intra mode may mean an intra-prediction mode, and the inter mode may mean an inter-prediction mode. The encoding apparatus 100 may generate a prediction block for an input block of the input image. In addition, the encoding apparatus 100 may encode a residual of the input block and the prediction block after the prediction block being generated. The input image may be called as a current image that is a current encoding target. The input block may be called as a current block that is current encoding target, or as an encoding target block.

When a prediction mode is an intra mode, the intra-prediction unit 120 may use a pixel value of a block that has been already encoded/decoded and is adjacent to a current block as a reference pixel. The intra-prediction unit 120 may perform spatial prediction by using a reference pixel, or generate prediction samples of an input block by performing spatial prediction. Herein, the intra prediction may mean intra-prediction.

When a prediction mode is an inter mode, the motion prediction unit 111 may retrieve a region that best matches with an input block from a reference image when performing motion prediction, and deduce a motion vector by using the retrieved region. The reference image may be stored in the reference picture buffer 190.

The motion compensation unit 112 may generate a prediction block by performing motion compensation using a motion vector. Herein, inter-prediction may mean inter-prediction or motion compensation.

When the value of the motion vector is not an integer, the motion prediction unit 111 and the motion compensation unit 112 may generate the prediction block by applying an interpolation filter to a partial region of the reference picture. In order to perform inter-picture prediction or motion compensation on a coding unit, it may be determined that which mode among a skip mode, a merge mode, an advanced motion vector prediction (AMVP) mode, and a current picture referring mode is used for motion prediction and motion compensation of a prediction unit included in the corresponding coding unit. Then, inter-picture prediction or motion compensation may be differently performed depending on the determined mode.

The subtractor 125 may generate a residual block by using a residual of an input block and a prediction block. The residual block may be called as a residual signal. The residual signal may mean a difference between an original signal and a prediction signal. In addition, the residual signal may be a signal generated by transforming or quantizing, or transforming and quantizing a difference between the original signal and the prediction signal. The residual block may be a residual signal of a block unit.

The transform unit 130 may generate a transform coefficient by performing transform of a residual block, and output the generated transform coefficient. Herein, the transform coefficient may be a coefficient value generated by performing transform of the residual block. When a transform skip mode is applied, the transform unit 130 may skip transform of the residual block.

A quantized level may be generated by applying quantization to the transform coefficient or to the residual signal. Hereinafter, the quantized level may be also called as a transform coefficient in embodiments.

The quantization unit 140 may generate a quantized level by quantizing the transform coefficient or the residual signal according to a parameter, and output the generated quantized level. Herein, the quantization unit 140 may quantize the transform coefficient by using a quantization matrix.

The entropy encoding unit 150 may generate a bitstream by performing entropy encoding according to a probability distribution on values calculated by the quantization unit 140 or on coding parameter values calculated when performing encoding, and output the generated bitstream. The entropy encoding unit 150 may perform entropy encoding of pixel information of an image and information for decoding an image. For example, the information for decoding the image may include a syntax element.

When entropy encoding is applied, symbols are represented so that a smaller number of bits are assigned to a symbol having a high chance of being generated and a larger number of bits are assigned to a symbol having a low chance of being generated, and thus, the size of bit stream for symbols to be encoded may be decreased. The entropy encoding unit 150 may use an encoding method for entropy encoding such as exponential Golomb, context-adaptive variable length coding (CAVLC), context-adaptive binary arithmetic coding (CABAC), etc. For example, the entropy encoding unit 150 may perform entropy encoding by using a variable length coding/code (VLC) table. In addition, the entropy encoding unit 150 may deduce a binarization method of a target symbol and a probability model of a target symbol/bin, and perform arithmetic coding by using the deduced binarization method, and a context model.

In order to encode a transform coefficient level, the entropy encoding unit 150 may change a two-dimensional block form coefficient into a one-dimensional vector form by using a transform coefficient scanning method.

A coding parameter may include information (flag, index, etc.) such as syntax element that is encoded in an encoder and signaled to a decoder, and information derived when performing encoding or decoding. The coding parameter may mean information required when encoding or decoding an image. For example, at least one value or a combination form of a unit/block size, a unit/block depth, unit/block partition information, unit/block partition structure, whether to partition of a quad-tree form, whether to partition of a binary-tree form, a partition direction of a binary-tree form (horizontal direction or vertical direction), a partition form of a binary-tree form (symmetric partition or asymmetric partition), an intra-prediction mode/direction, a reference sample filtering method, a prediction block filtering method, a prediction block filter tap, a prediction block filter coefficient, an inter-prediction mode, motion information, a motion vector, a reference picture index, a inter-prediction angle, an inter-prediction indicator, a reference picture list, a reference picture, a motion vector predictor candidate, a motion vector candidate list, whether to use a merge mode, a merge candidate, a merge candidate list, whether to use a skip mode, an interpolation filter type, an interpolation filter tab, an interpolation filter coefficient, a motion vector size, a presentation accuracy of a motion vector, a transform type, a transform size, information of whether or not a primary(first) transform is used, information of whether or not a secondary transform is used, a primary transform index, a secondary transform index, information of whether or not a residual signal is present, a coded block pattern, a coded block flag(CBF), a quantization parameter, a quantization matrix, whether to apply an intra loop filter, an intra loop filter coefficient, an intra loop filter tab, an intra loop filter shape/form, whether to apply a deblocking filter, a deblocking filter coefficient, a deblocking filter tab, a deblocking filter strength, a deblocking filter shape/form, whether to apply an adaptive sample offset, an adaptive sample offset value, an adaptive sample offset category, an adaptive sample offset type, whether to apply an adaptive in-loop filter, an adaptive in-loop filter coefficient, an adaptive in-loop filter tab, an adaptive in-loop filter shape/form, a binarization/inverse-binarization method, a context model determining method, a context model updating method, whether to perform a regular mode, whether to perform a bypass mode, a context bin, a bypass bin, a transform coefficient, a transform coefficient level, a transform coefficient level scanning method, an image displaying/outputting sequence, slice identification information, a slice type, slice partition information, tile identification information, a tile type, tile partition information, a picture type, a bit depth, and information of a luma signal or chroma signal may be included in the coding parameter.

Herein, signaling the flag or index may mean that a corresponding flag or index is entropy encoded and included in a bitstream by an encoder, and may mean that the corresponding flag or index is entropy decoded from a bitstream by a decoder.

When the encoding apparatus 100 performs encoding through inter-prediction, an encoded current image may be used as a reference image for another image that is processed afterwards. Accordingly, the encoding apparatus 100 may reconstruct or decode the encoded current image, or store the reconstructed or decoded image as a reference image.

A quantized level may be dequantized in the dequantization unit 160, or may be inverse-transformed in the inverse-transform unit 170. A dequantized or inverse-transformed coefficient or both may be added with a prediction block by the adder 175. By adding the dequantized or inverse-transformed coefficient or both with the prediction block, a reconstructed block may be generated. Herein, the dequantized or inverse-transformed coefficient or both may mean a coefficient on which at least one of dequantization and inverse-transform is performed, and may mean a reconstructed residual block.

A reconstructed block may pass through the filter unit 180. The filter unit 180 may apply at least one of a deblocking filter, a sample adaptive offset (SAO), and an adaptive loop filter (ALF) to the reconstructed block or a reconstructed image. The filter unit 180 may be called as an in-loop filter.

The deblocking filter may remove block distortion generated in boundaries between blocks. In order to determine whether or not to apply a deblocking filter, whether or not to apply a deblocking filter to a current block may be determined based pixels included in several rows or columns which are included in the block. When a deblocking filter is applied to a block, another filter may be applied according to a required deblocking filtering strength.

In order to compensate an encoding error, a proper offset value may be added to a pixel value by using a sample adaptive offset. The sample adaptive offset may correct an offset of a deblocked image from an original image by a pixel unit. A method of partitioning pixels of an image into a predetermined number of regions, determining a region to which an offset is applied, and applying the offset to the determined region, or a method of applying an offset in consideration of edge information on each pixel may be used.

The adaptive loop filter may perform filtering based on a comparison result of the filtered reconstructed image and the original image. Pixels included in an image may be partitioned into predetermined groups, a filter to be applied to each group may be determined, and differential filtering may be performed for each group. Information of whether or not to apply the ALF may be signaled by coding units (CUs), and a form and coefficient of the ALF to be applied to each block may vary.

The reconstructed block or the reconstructed image having passed through the filter unit 180 may be stored in the reference picture buffer 190. FIG. 2 is a block diagram showing a configuration of a decoding apparatus according to an embodiment and to which the present invention is applied.

A decoding apparatus 200 may a decoder, a video decoding apparatus, or an image decoding apparatus.

Referring to FIG. 2, the decoding apparatus 200 may include an entropy decoding unit 210, a dequantization unit 220, a inverse-transform unit 230, an intra-prediction unit 240, a motion compensation unit 250, an adder 225, a filter unit 260, and a reference picture buffer 270.

The decoding apparatus 200 may receive a bitstream output from the encoding apparatus 100. The decoding apparatus 200 may receive a bitstream stored in a computer readable recording medium, or may receive a bitstream that is streamed through a wired/wireless transmission medium. The decoding apparatus 200 may decode the bitstream by using an intra mode or an inter mode. In addition, the decoding apparatus 200 may generate a reconstructed image generated through decoding or a decoded image, and output the reconstructed image or decoded image.

When a prediction mode used when decoding is an intra mode, a switch may be switched to an intra. Alternatively, when a prediction mode used when decoding is an inter mode, a switch may be switched to an inter mode.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block with the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be a inverse-process of the entropy encoding method described above.

In order to decode a transform coefficient level, the entropy decoding unit 210 may change a one-directional vector form coefficient into a two-dimensional block form by using a transform coefficient scanning method.

A quantized level may be dequantized in the dequantization unit 220, or inverse-transformed in the inverse-transform unit 230. The quantized level may be a result of dequantizing or inverse-transforming or both, and may be generated as a reconstructed residual block. Herein, the dequantization unit 220 may apply a quantization matrix to the quantized level.

When an intra mode is used, the intra-prediction unit 240 may generate a prediction block by performing spatial prediction that uses a pixel value of a block adjacent to a decoding target block and which has been already decoded.

When an inter mode is used, the motion compensation unit 250 may generate a prediction block by performing motion compensation that uses a motion vector and a reference image stored in the reference picture buffer 270.

The adder 225 may generate a reconstructed block by adding the reconstructed residual block with the prediction block. The filter unit 260 may apply at least one of a deblocking filter, a sample adaptive offset, and an adaptive loop filter to the reconstructed block or reconstructed image. The filter unit 260 may output the reconstructed image. The reconstructed block or reconstructed image may be stored in the reference picture buffer 270 and used when performing inter-prediction.

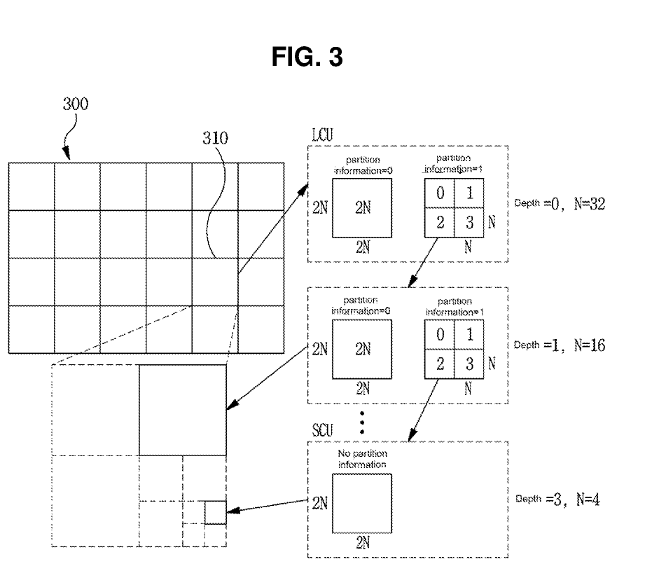

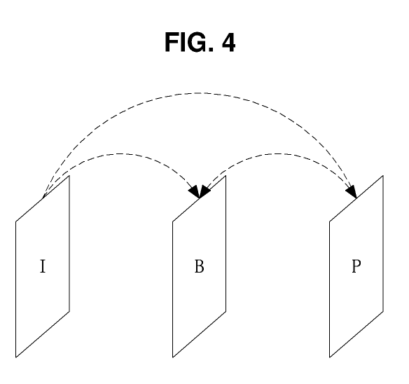

FIG. 3 is a view schematically showing a partition structure of an image when encoding and decoding the image. FIG. 3 schematically shows an example of partitioning a single unit into a plurality of lower units.

In order to efficiently partition an image, when encoding and decoding, a coding unit (CU) may be used. The coding unit may be used as a basic unit when encoding/decoding the image. In addition, the coding unit may be used as a unit for distinguishing an intra mode and an inter mode when encoding/decoding the image. The coding unit may be a basic unit used for prediction, transform, quantization, inverse-transform, dequantization, or an encoding/decoding process of a transform coefficient.

Referring to FIG. 3, an image 300 is sequentially partitioned in a largest coding unit (LCU), and a LCU unit is determined as a partition structure. Herein, the LCU may be used in the same meaning as a coding tree unit (CTU). A unit partitioning may mean partitioning a block associated with to the unit. In block partition information, information of a unit depth may be included. Depth information may represent a number of times or a degree or both in which a unit is partitioned. A single unit may be partitioned in a layer associated with depth information based on a tree structure. Each of partitioned lower unit may have depth information. Depth information may be information representing a size of a CU, and may be stored in each CU.

A partition structure may mean a distribution of a coding unit (CU) within an LCU 310. Such a distribution may be determined according to whether or not to partition a single CU into a plurality (positive integer equal to or greater than 2 including 2, 4, 8, 16, etc.) of CUs. A horizontal size and a vertical size of the CU generated by partitioning may respectively be half of a horizontal size and a vertical size of the CU before partitioning, or may respectively have sizes smaller than a horizontal size and a vertical size before partitioning according to a number of times of partitioning. The CU may be recursively partitioned into a plurality of CUs. Partitioning of the CU may be recursively performed until to a predefined depth or predefined size. For example, a depth of an LCU may be 0, and a depth of a smallest coding unit (SCU) may be a predefined maximum depth. Herein, the LCU may be a coding unit having a maximum coding unit size, and the SCU may be a coding unit having a minimum coding unit size as described above. Partitioning is started from the LCU 310, a CU depth increases by 1 as a horizontal size or a vertical size or both of the CU decreases by partitioning.

In addition, information whether or not the CU is partitioned may be represented by using partition information of the CU. The partition information may be 1-bit information. All CUs, except for a SCU, may include partition information. For example, when a value of partition information is 1, the CU may not be partitioned, when a value of partition information is 2, the CU may be partitioned.

Referring to FIG. 3, an LCU having a depth 0 may be a 64×64 block. 0 may be a minimum depth. A SCU having a depth 3 may be an 8×8 block. 3 may be a maximum depth. A CU of a 32×32 block and a 16×16 block may be respectively represented as a depth 1 and a depth 2.

For example, when a single coding unit is partitioned into four coding units, a horizontal size and a vertical size of the four partitioned coding units may be a half size of a horizontal and vertical size of the CU before being partitioned. In one embodiment, when a coding unit having a 32×32 size is partitioned into four coding units, each of the four partitioned coding units may have a 16×16 size. When a single coding unit is partitioned into four coding units, it may be called that the coding unit may be partitioned into a quad-tree form.

For example, when a single coding unit is partitioned into two coding units, a horizontal or vertical size of the two coding units may be a half of a horizontal or vertical size of the coding unit before being partitioned. For example, when a coding unit having a 32×32 size is partitioned in a vertical direction, each of two partitioned coding units may have a size of 16×32. When a single coding unit is partitioned into two coding units, it may be called that the coding unit is partitioned in a binary-tree form. An LCU 320 of FIG. 3 is an example of an LCU to which both of partitioning of a quad-tree form and partitioning of a binary-tree form are applied.

FIG. 4 is a diagram illustrating an embodiment of an inter-picture prediction process.

In FIG. 4, a rectangle may represent a picture. In FIG. 4, an arrow represents a prediction direction. Pictures may be categorized into intra pictures (I pictures), predictive pictures (P pictures), and Bi-predictive pictures (B pictures) according to the encoding type thereof.

The I picture may be encoded through intra-prediction without requiring inter-picture prediction. The P picture may be encoded through inter-picture prediction by using a reference picture that is present in one direction (i.e., forward direction or backward direction) with respect to a current block. The B picture may be encoded through inter-picture prediction by using reference pictures that are preset in two directions (i.e., forward direction and backward direction) with respect to a current block. When the inter-picture prediction is used, the encoder may perform inter-picture prediction or motion compensation and the decoder may perform the corresponding motion compensation.

Hereinbelow, an embodiment of the inter-picture prediction will be described in detail.

The inter-picture prediction or motion compensation may be performed using a reference picture and motion information.

Motion information of a current block may be derived during inter-picture prediction by each of the encoding apparatus 100 and the decoding apparatus 200. The motion information of the current block may be derived by using motion information of a reconstructed neighboring block, motion information of a collocated block (also referred to as a col block or a co-located block), and/or a block adjacent to the co-located block. The co-located block may mean a block that is located spatially at the same position as the current block, within a previously reconstructed collocated picture (also referred to as a col picture or a co-located picture). The co-located picture may be one picture among one or more reference pictures included in a reference picture list.

A method of deriving the motion information of the current block may vary depending on a prediction mode of the current block. For example, as prediction modes for inter-picture prediction, there may be an AMVP mode, a merge mode, a skip mode, a current picture reference mode, etc. The merge mode may be referred to as a motion merge mode.

For example, when the AMVP is used as the prediction mode, at least one of motion vectors of the reconstructed neighboring blocks, motion vectors of the co-located blocks, motion vectors of blocks adjacent to the co-located blocks, and a (0, 0) motion vector may be determined as motion vector candidates for the current block, and a motion vector candidate list is generated by using the emotion vector candidates. The motion vector candidate of the current block can be derived by using the generated motion vector candidate list. The motion information of the current block may be determined based on the derived motion vector candidate. The motion vectors of the collocated blocks or the motion vectors of the blocks adjacent to the collocated blocks may be referred to as temporal motion vector candidates, and the motion vectors of the reconstructed neighboring blocks may be referred to as spatial motion vector candidates.

The encoding apparatus 100 may calculate a motion vector difference (MVD) between the motion vector of the current block and the motion vector candidate and may perform entropy encoding on the motion vector difference (MVD). In addition, the encoding apparatus 100 may perform entropy encoding on a motion vector candidate index and generate a bitstream. The motion vector candidate index may indicate an optimum motion vector candidate among the motion vector candidates included in the motion vector candidate list. The decoding apparatus may perform entropy decoding on the motion vector candidate index included in the bitstream and may select a motion vector candidate of a decoding target block from among the motion vector candidates included in the motion vector candidate list by using the entropy-decoded motion vector candidate index. In addition, the decoding apparatus 200 may add the entropy-decoded MVD and the motion vector candidate extracted through the entropy decoding, thereby deriving the motion vector of the decoding target block.

The bitstream may include a reference picture index indicating a reference picture. The reference picture index may be entropy-encoded by the encoding apparatus 100 and then signaled as a bitstream to the decoding apparatus 200. The decoding apparatus 200 may generate a prediction block of the decoding target block based on the derived motion vector and the reference picture index information.

Another example of the method of deriving the motion information of the current may be the merge mode. The merge mode may mean a method of merging motion of a plurality of blocks. The merge mode may mean a mode of deriving the motion information of the current block from the motion information of the neighboring blocks. When the merge mode is applied, the merge candidate list may be generated using the motion information of the reconstructed neighboring blocks and/or the motion information of the collocated blocks. The motion information may include at least one of a motion vector, a reference picture index, and an inter-picture prediction indicator. The prediction indicator may indicate one-direction prediction (L0 prediction or L1 prediction) or two-direction predictions (L0 prediction and L1 prediction).

The merge candidate list may be a list of motion information stored. The motion information included in the merge candidate list may be at least either one of the zero merge candidate and new motion information that is a combination of the motion information (spatial merge candidate) of one neighboring block adjacent to the current block, the motion information (temporal merge candidate) of the collocated block of the current block, which is included within the reference picture, and the motion information exiting in the merge candidate list.

The encoding apparatus 100 may generate a bitstream by performing entropy encoding on at least one of a merge flag and a merge index and may signal the bitstream to the decoding apparatus 200. The merge flag may be information indicating whether or not to perform the merge mode for each block, and the merge index may be information indicating that which neighboring block, among the neighboring blocks of the current block, is a merge target block. For example, the neighboring blocks of the current block may include a left neighboring block on the left side of the current block, an upper neighboring block disposed above the current block, and a temporal neighboring block temporally adjacent to the current block.

The skip mode may be a mode in which the motion information of the neighboring block is applied to the current block as it is. When the skip mode is applied, the encoding apparatus 100 may perform entropy encoding on information of the fact that the motion information of which block is to be used as the motion information of the current block to generate a bit stream, and may signal the bitstream to the decoding apparatus 200. The encoding apparatus 100 may not signal a syntax element regarding at least any one of the motion vector difference information, the encoding block flag, and the transform coefficient level to the decoding apparatus 200.

The current picture reference mode may mean a prediction mode in which a previously reconstructed region within a current picture to which the current block belongs is used for prediction. Here, a vector may be used to specify the previously-reconstructed region. Information indicating whether the current block is to be encoded in the current picture reference mode may be encoded by using the reference picture index of the current block. The flag or index indicating whether or not the current block is a block encoded in the current picture reference mode may be signaled, and may be deduced based on the reference picture index of the current block. In the case where the current block is encoded in the current picture reference mode, the current picture may be added to the reference picture list for the current block so as to be located at a fixed position or a random position in the reference picture list. The fixed position may be, for example, a position indicated by a reference picture index of 0, or the last position in the list. When the current picture is added to the reference picture list so as to be located at the random position, the reference picture index indicating the random position may be signaled.

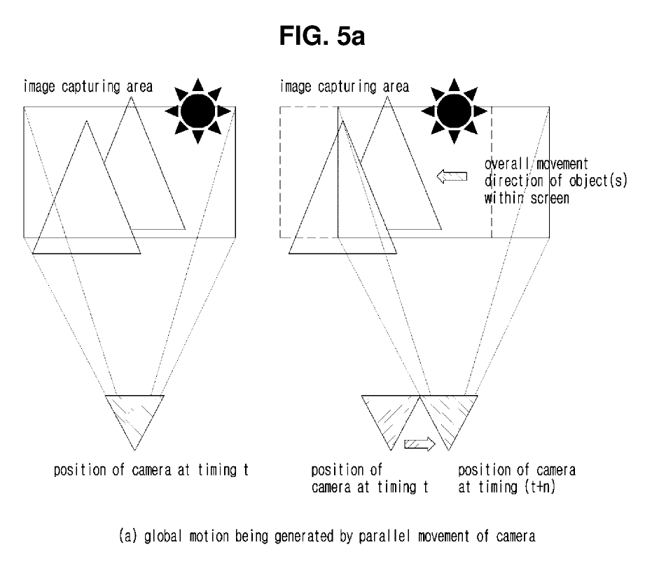

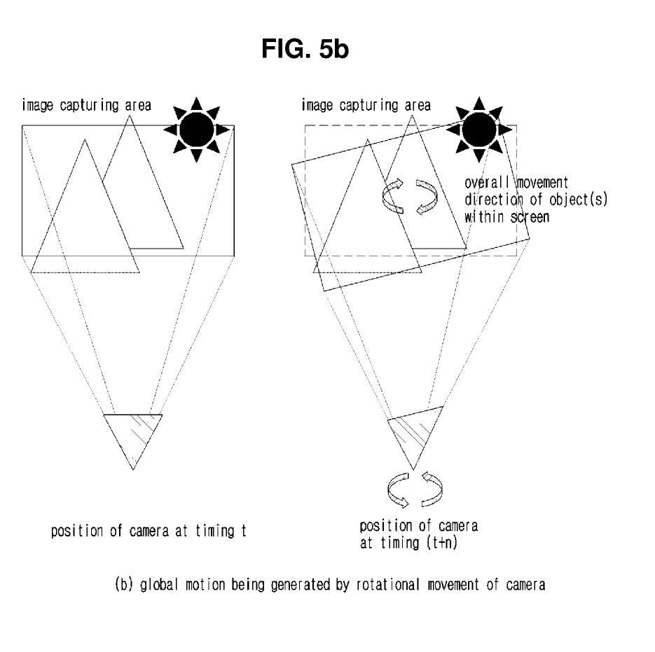

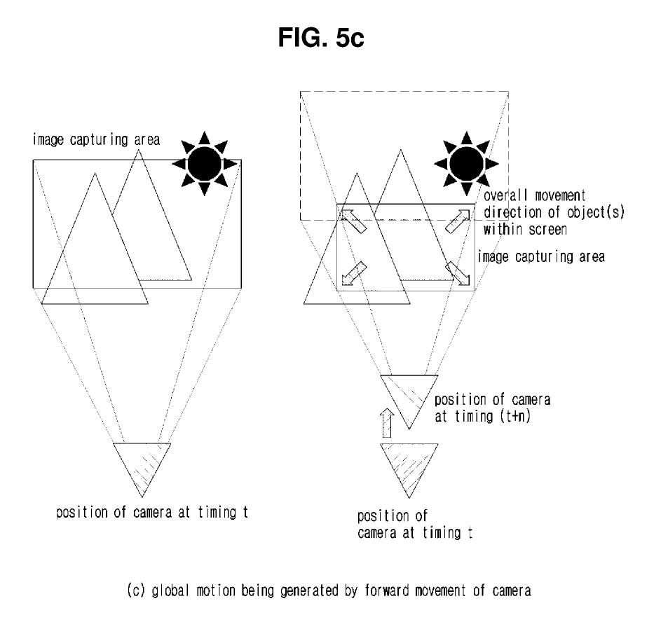

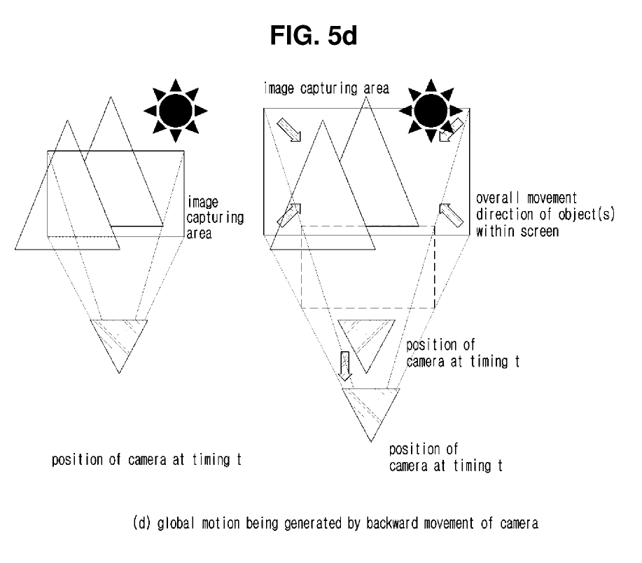

Hereinafter, image encoding/decoding methods using global motion information according to the present invention will be described with reference to FIGS. 5 to 15.

A video includes global motions and local motions according to a time flow within the video. A global motion may refer to a motion having tendency which is included in the entire image. The global motion may be generated by a camera work or common motion across the entire captured area. Herein, the global motion may be a concept of including a global motion, and the local motion may be a concept of including a local motion. Accordingly, in the present description, the global motion may be called a global motion, global motion information may be called global motion information, the local motion may be called a local motion, and local motion information may be called local motion information.

In addition, in the present description, a frame may be called a picture, a reference frame may be called a reference picture, and a current frame may be called a current picture.

FIG. 5 is a view for illustrating a generation example of a global motion.

Referring to FIG. 5, when camera work by a parallel movement is used as shown in FIG. 5a, most of objects within an image include (carries) parallel motions in a specific direction.

When camera work that rotates a camera capturing images is used as shown in FIG. 5b, most of objects within an image include (carries) motions that rotate in a specific direction.

When a camera work that forwardly moves the camera is used as shown in FIG. 5c, a motion in which objects within an image are scaled up is shown.

When a camera work that backwardly moves the camera is used as shown in FIG. 5d, a motion in which objects within an image are scaled down is shown.

A local motion may mean a case when an image includes a motion different from the global motion within the image. This may refer to a case including an additional motion while including a global motion, or may be a case including a motion completely different from the global motion.

For example, when most objects within an image move in a left direction due to the image using a panning method, and an object moving in an opposite direction may mean that the object includes a local motion.

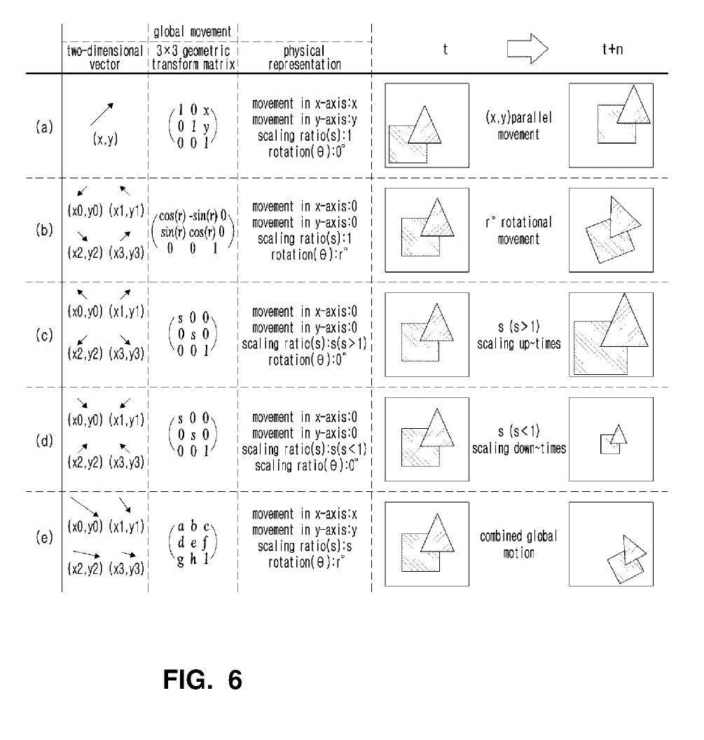

FIG. 6 is a view for illustrating an example method of representing a global motion of an image.

FIG. 6(a) shows a method of representing a global motion generated by a parallel movement. A two-dimensional vector is represented in two values: an x variable meaning a parallel movement in an x-axis; and a y variable meaning a parallel movement in a y-axis. When a global motion generated by a parallel movement is represented in a 3×3 geometric transform matrix, among nine variables, only two variables have values in which the parallel movement is reflected, and remaining seven values have fixed values. When four variables representing an x-axial movement, a y-axial movement, a scaling up/down (scaling ratio), and a rotation are represented in a physical representing method of representing a global motion of an image, among four variables, variables of an x-axial movement and a y-axial movement which represent a parallel movement may have values in which the parallel movement is reflected, a scaling ratio variable may be 1 since there is no scaling up/down. In addition, since there was no rotation, a rotation variable may be represented to have a rotation angle being 0 degree.

FIG. 6(b) shows a method of representing a global motion generated by a rotation motion. A rotation movement may not be represented by using a single two-dimensional vector. In FIG. 6(b), four two-dimensional vectors are used for representing a rotation movement, when a large number of two-dimensional vectors is used, a rotation movement may be represented more accurately. However, when a large number of two-dimensional vectors is used, an additional information amount used for representing a global motion increases so that coding efficiency decreases. Accordingly, there is a need for using a proper number of two-dimensional vectors in consideration of prediction accuracy and an additional information amount. In addition, a global motion reflecting each detailed area may be calculated by using two-dimensional motion vectors used for representing a global motion, and the calculated global motion may be used. When a global motion generated by a rotation movement is represented in a 3×3 geometric transform matrix, among nine variables, four variables have values in which the rotation movement is reflected, and the remaining five variables have fixed values. Herein, the four variables in which the rotation movement is reflected are represented by cosine and sine functions rather than a rotation angle. When the four variables representing an x-axial movement, a y-axial movement, a scaling up/down (scaling ratio), and a rotation (angle) are represented by a physical representation method that represents a global motion of an image, among four variables, a rotation variable representing the rotation movement has a value in which the rotation movement is reflected, and a scaling ratio is 1 since there is no scaling up/down. In addition, it is represented that there is no movement by representing an x-axial movement and a y-axial movement to have values being 0 since there is no parallel movement.

FIG. 6(c) represents a global motion generated by a scaling up, and FIG. 6(d) represents a global motion generated by a scaling down. Similarly to a rotation movement, scaling up/down movements may not be represented by using a single two-dimensional vector. Accordingly, similarly to a rotation movement, information of a number of two-dimensional vectors may be used. Examples of FIGS. 6(c) and 6(d) are represented by using four two-dimensional vectors. When each global motion generated by scaling up/down is represented in a 3×3 geometric transform matrixes, among nine variables, two variables have values in which the scaling up/down is reflected. Herein, each variable may be divided into an x-axial scaling up/down ratio and a y-axial scaling up/down ratio. An example of FIG. 6 shows cases when the x-axial scaling up/down ratio and the y-axial scaling up/down ratio are identical. When four variables representing an x-axial movement, a y-axial movement, a scaling up/down (scaling ratio), and a rotation (angle) are represented in a physical representation method that represents a global motion of an image, among four variables, a scaling ratio variable representing a scaling up/down has a value in which the scaling up/down is reflected, and remaining values have values that are constant. Herein, since a single scaling ratio variable is present, a case in which the entire image has a constant scaling ratio may be represented. In order to separately represent the x-axial scaling ratio and the y-axial scaling ratio, two scaling ratio variables are required.

FIG. 6(e) is an example of a global motion when a parallel movement, a rotation, and a scaling up/down are generated at the same time. Since a rotation and a scaling down are reflected, the global motion may not be represented by using a single two-dimensional vector. Accordingly, global motion may be represented by using a plurality of two-dimensional vectors. When a 3×3 geometric transform matrix is used, among nine variables, eight variables are used for representing the global motion. Herein, each variable of the matrix represents a combination of a complex and continuous global motion, thus it may be difficult to describe which motion is reflected by which variable. In addition, when eight variables of the 3×3 matrix are used, a global motion generated by a perspective transform that is not included in an example of FIG. 6(e) may be represented. When four variables representing an x-axial movement, a y-axial movement, a scaling up/down (scaling ratio), a rotation (angle) are represented in a physical representation method that represents a global motion of an image, four variables are used to represent respective motions.

When a global motion is represented by using a two-dimensional motion vector, two variables are used just in case for representing a parallel movement, thus the global motion may be represented with a few amount of additional information. When representing a global motion that is more complicated than a global motion including a rotation, a scaling down, etc., it becomes difficult to accurately represent the global motion, and a large amount of additional information is used for accurately representing the same. Accordingly, coding efficiency may decrease.

When a 3×3 geometric transform matrix is used, a global motion may be represented very accurately. In general, eight variable values, except for a single constant variable, are required, thus coding efficiency may decrease since the global motion is represented by using a large amount of additional information.

When a physical representation method is used, a necessary global motion may be selectively used. However, there is a limit to precisely represent the global motion than by using a 3×3 geometric transform matrix. In order to compensate the same, a large number of variables may be used. For example, when the center of a rotation or a scaling up/down is not the center of an image, variables representing the central position may be added since there is a limit of representing by using the physical representation method of FIG. 6.

In order to improve encoding performance, the image encoder and decoder may use a method that maximally excludes an image redundancy. In a method of excluding an image redundancy, in order to accurately exclude redundant information, motions of objects within the image may be predicted and used. Herein, in general, a motion prediction is performed by dividing the image into areas

In one embodiment, in HEVC/H.265, an image is used by being divided into a square or rectangle shape such as coding unit, prediction unit, and the shape also includes a macro block.

This is for considering various local motions within the image, and also for performing a motion prediction more precisely. During the process, information representing a motion of each area is generated, generated local motion information is encoded and additionally included in a bitstream, and the additional included local motion information occupies a large number of bits within the bitstream. For the above mentioned reasons, local motion information may be predicted and used by being compressed using an entropy coding method.

In addition, since the local motion information generated as above generally includes a global motion, in order to compress the local motion information, a method of using global motion information that is overall tendency included in the local motion information is present. By representing the global motion, the local motion may be represented by representing a difference with the global motion. When the local motion includes a number of global motions, the difference therebetween becomes small, thus a symbol amount to be represented may decrease.

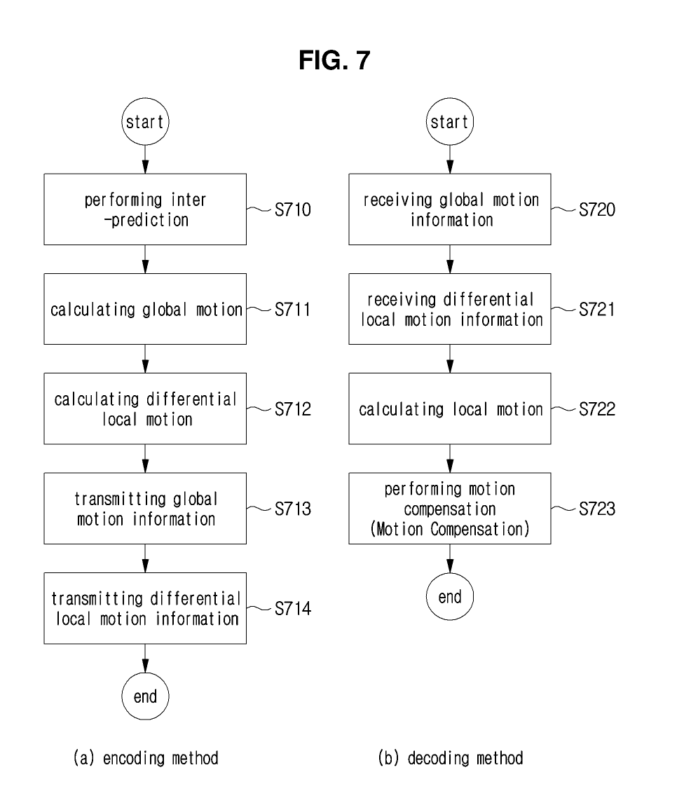

FIG. 7 is a flowchart for illustrating encoding method and decoding methods of using global motion information.

Referring to FIG. 7, in step S710, a local motion may be determined by performing inter-prediction, and in step S711, a global motion may be calculated. Then, in step S712, the local motion and the global motion may be separated by excluding the global motion included in the local motion by using differences between individual local motions and the calculated global motion. Accordingly, in steps S713 and S714, calculated differential local motion information and global motion information may be transmitted. In steps S720 and S721, a decoder may receive global motion information and differential local motion information, and in step S722, original individual local motion information may be reconstructed by using the information. Then, in step S723, the decoder may perform motion compensation by using the reconstructed local motion.

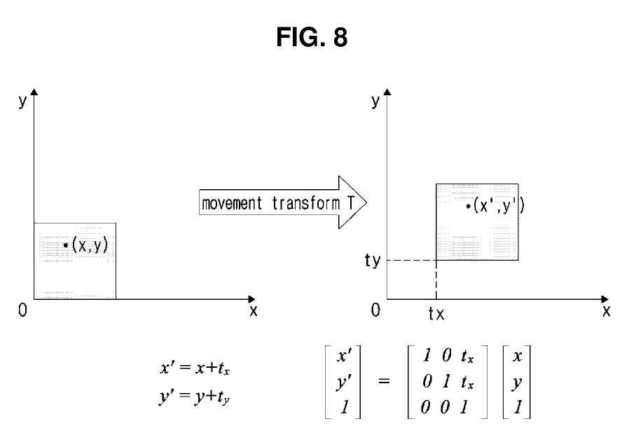

FIGS. 8 to 12 are views for illustrating examples of a geometric transform of an image to represent a global motion.

In a video coding method reflecting a global motion, a coding method using an image geometric transform may be present. The image geometric transform means modifying an image by reflecting a geometric motion to a position of pixel information included in the image.

Pixel information may mean a luminance value of each point of an image, and may mean a color and a chroma. In addition, the pixel information may mean a pixel value in a digital image. A geometric modification may mean a parallel movement, a rotation, a size change of each point including pixel information within an image, and may be used for representing global motion information.

In FIGS. 8 to 12, (x,y) may mean a point of an original image to which transform is not applied, (x′,y′) may mean a point corresponding to (x,y) within an image to which transform is applied. Herein, the corresponding point may mean a point generated by moving (x,y) by transforming luma information thereof.

FIG. 8 is a view showing a transform example when each point of an image moves in parallel. tx means a movement displacement of each point in an x-axis, and ty means a movement displacement of each point in a y-axis. Accordingly, a moved point (x′,y′) may be determined by adding tx and ty to each point (x,y) of the image. The above movement transform may be represented in a determinant of FIG. 8.

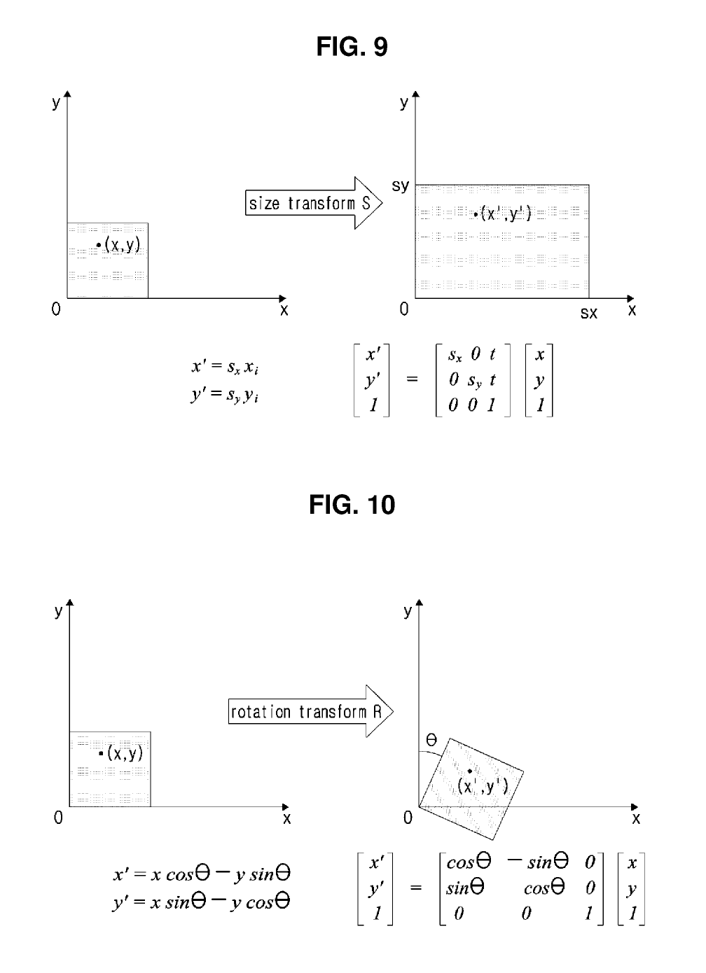

FIG. 9 is a view showing an image transform example generated by a size modification. sx means a scaling ratio in an x-axial size modification, and sy means a scaling ratio in a y-axial size modification. A scaling ratio in a size modification being 1 means that the modified size of the image is identical to an original size. When the scaling ratio in the size modification is greater than 1, it means that the image is scaled up, and when the scaling ratio of the size modification is smaller than 1, it means that the image is scaled down. In addition, the scaling ratio in the size modification has a value being always greater than 0. Accordingly, a size modified point (x′,y′) may be determined by multiplying each point (x,y) of the image by sx and sy. A size transform may be represented in a determinant of FIG. 9.

FIG. 10 is a view showing an image transform example generated by a rotation modification. 8 means a rotation angle of an image. The example of FIG. 10 shows a rotation based on a (0,0) point of the image. By using 0 and a trigonometrical function, a rotated point of the image may be calculated. This may be represented in a determinant of FIG. 10.

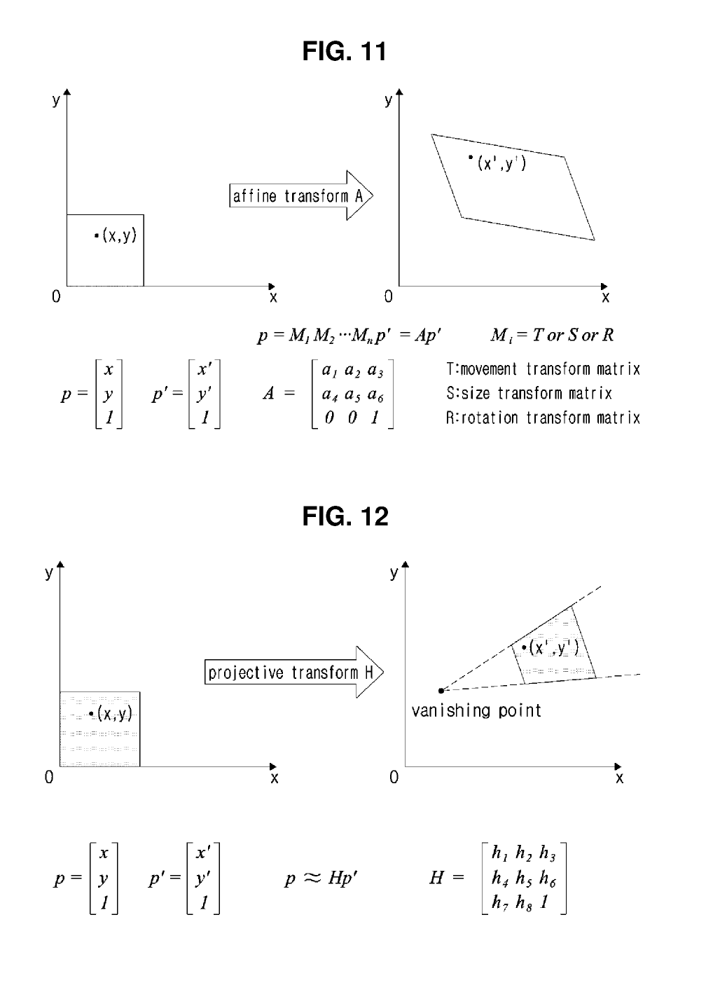

FIG. 11 is a view showing an example of an affine transform. The affine transform means a case in which a movement transform, a size transform, and a rotation transform are in combination. A geometric transform form by an affine transform may vary according to an order of each of a movement transform, a size transform, and a rotation transform. According to a transform order and a combination thereof, a modification form in which an image area is inclined may be obtained in addition to the movement, size modification, and rotation transform. M of FIG. 11 may have a 3×3 matrix form, and may be one of a movement geometric transform matrix, a size geometric transform matrix, and a rotation geometric transform matrix. Such a combined matrix may be represented in a single 3×3 matrix form by using a matrix multiplication, and represented in a form of a matrix A of FIG. 11. a1˜a6 means elements of the matrix A. p means an arbitrary point of an original image represented by the matrix, and p′ means a point of a geometric transformed image and which corresponds to the point p of the original image represented by the matrix. Accordingly, the affine transform may be represented in a determinant form of p=Ap′.

FIG. 12 is a view showing an example of a projective transform. The projective transform may be an extended transform method to which an affine transform form and a perspective modification is applied. When an object of a three-dimensional space is projected on a two-dimensional planar surface, according to a viewing angle of a camera or observer, a perspective modification is applied. The perspective modification refers to an object being far away appearing to be small, and a nearby object appearing to be large. The projective transform may be a form in which a perspective modification is additionally considered in an affine transform. A matrix representing the projective transform is H shown in FIG. 12. Values of h1˜h6 elements constituting the H correspond to a1˜a6 of the affine transform of FIG. 12 thereby the projective transform includes the affine transform. h7 and h8 are elements for considering the perspective transform.

Video coding using an image geometric transform is a video coding method using additional information that is generated by an image geometric transform of an inter-prediction method using motion information. Additional information (or geometric transform information) may refer to all kinds of information that enables easy prediction of a reference image or a partial area of the reference image, and an image for which prediction is performed by using the reference image or a partial area thereof. In one embodiment, the information may be a global motion vector, an affine geometric transform matrix, a projective geometric transform matrix, etc. In addition, the geometric transform information may include global motion information.

By using geometric transform information, image coding efficiency that is degraded due to a conventional method such as rotation, scaling up/down of an image may be improved. An encoder may analyze a relationship between a current frame and a reference frame, generate geometric transform information that transforms the reference frame to a form close to the current frame by using the analyzed relationship, and generate an additional reference frame (transform frame).

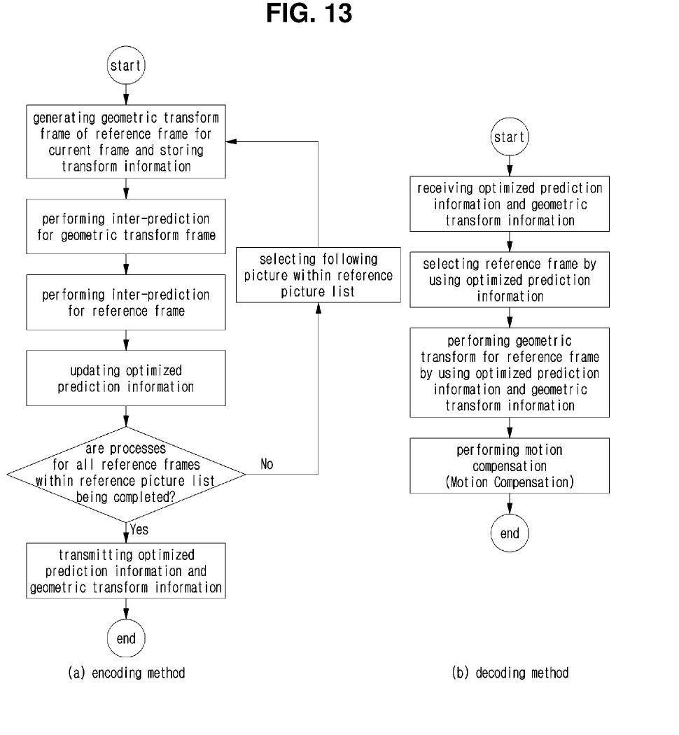

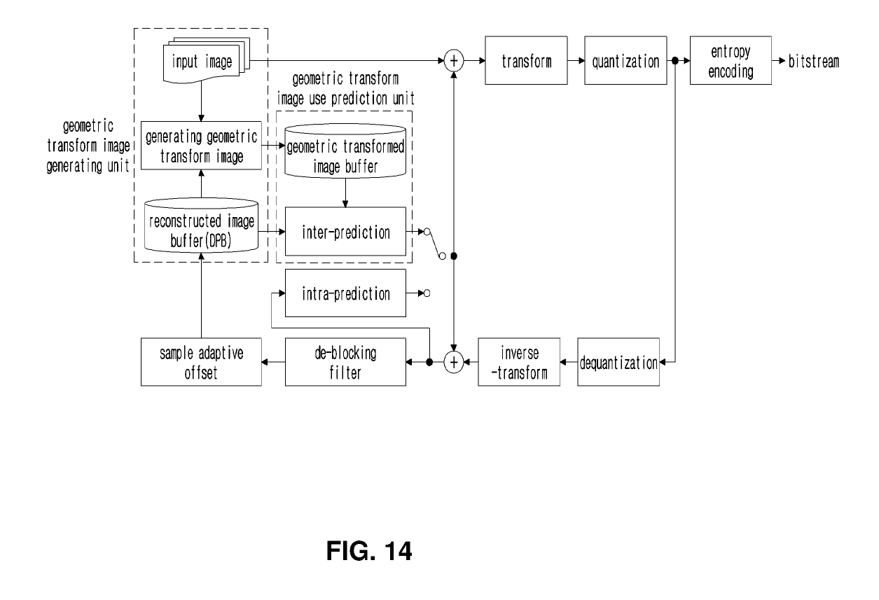

Optimized coding efficiency may be obtained by using both of a reference frame for which a modification process is performed during inter-prediction, and an original reference frame. Examples of encoding and decoding methods using an image geometric transform are as shown in FIG. 13, and an example of an encoding apparatus using an image geometric transform is as shown in FIG. 14.

As a result, motion information and selected reference frame information may be obtained. Herein, the selected reference frame information may include an index value capable of distinguishing the selected reference frame among a plurality of reference frames, and a value indicating whether or not the selected reference frame is a geometric transformed reference frame. The above information may be transmitted in various units. For example, when the information is applied to a block unit prediction structure used in HEVC codec, the information may be transmitted in a coding unit (hereinafter, ‘CU’), or a prediction unit (hereinafter, ‘PU’).

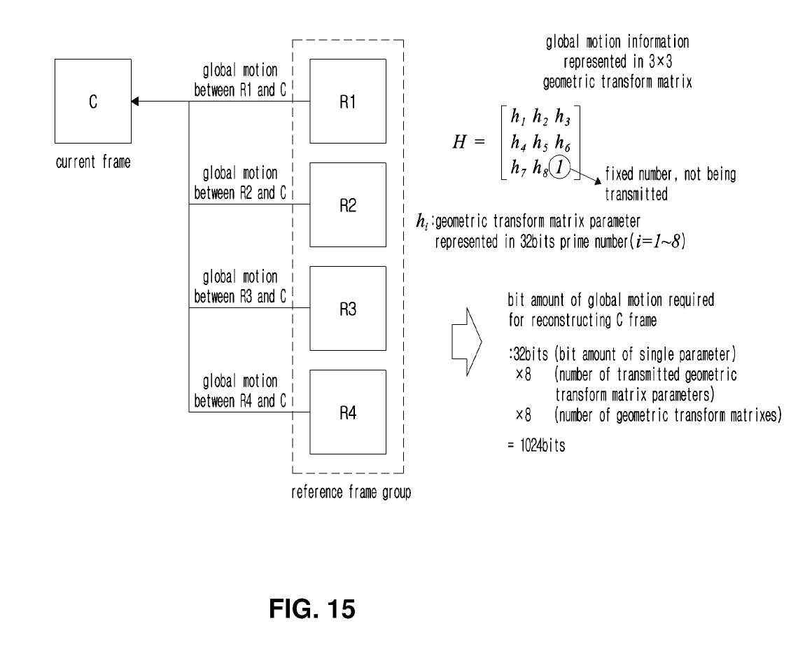

FIG. 15 is a view for illustrating an example of representing a global motion that requires a large number of bits.

Referring to FIG. 15, in order to represent global motions between a current frame (C) and reference frames (R1, R2, R3, and R4), the global motions may be represented in a 3×3 geometric transform matrix. Herein, a single parameter may have a bit amount of 32 bits, a number of parameters transmitted in a geometric transform matrix may be eight.

Herein, a bit amount of global motion information required for reconstructing the current frame (C) may be calculated as 1024 bits.

In other words, when global motion information is used for all reference frames of the current frame, the global motion information may occupy a large number of bits within a bitstream.

Based on the above, a method of predicting global motion information according to the present invention will be described in detail.

During encoding and decoding a current frame, global motion information is used in encoding, and thus loss caused by additional information occurs. In order to reduce the loss so as to enhance encoding efficiency, the present invention is intended to reduce the amount of transmitted information by predicting global motion information. Here, information included in a reference frame is a set of reference information including image pixel information required for encoding and decoding the current frame, motion information, prediction information, etc. The information included in the reference frame may include global motion information, and when the global motion information is not included, the global motion information may be predicted through a local motion.

Here, motion information included in the reference frame indicates a relation between the third reference frame used to reconstruct the reference frame and the reference frame.

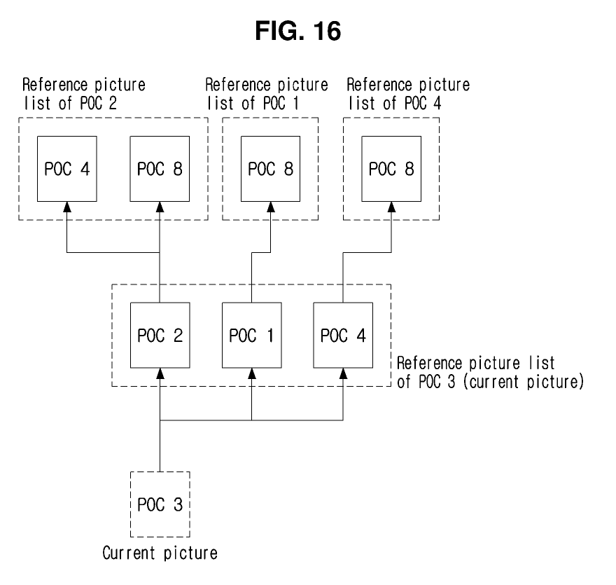

FIG. 16 is a view illustrating an example of a relation between reference frames.

Referring to FIG. 16, pictures of POC 2, POC 1, and POC 4 are used to reconstruct POC 3 which is a current picture (frame). These three pictures are required to be reconstructed before POC 3 which is the current picture. Each of three pictures may have a picture referenced to reconstruct itself, and has a reference picture list.

The present invention uses global motion information of a reference frame and the third reference frame used to reconstruct the reference frame so as to predict a global motion relation between a current frame required to be reconstructed and the reference frame, thereby enhancing encoding efficiency. Here, a correlation between global motion information included in the reference frame and global motion information predicted from local motion information is used to predict a global motion between the current frame and the reference frame, whereby encoding efficiency can be enhanced.

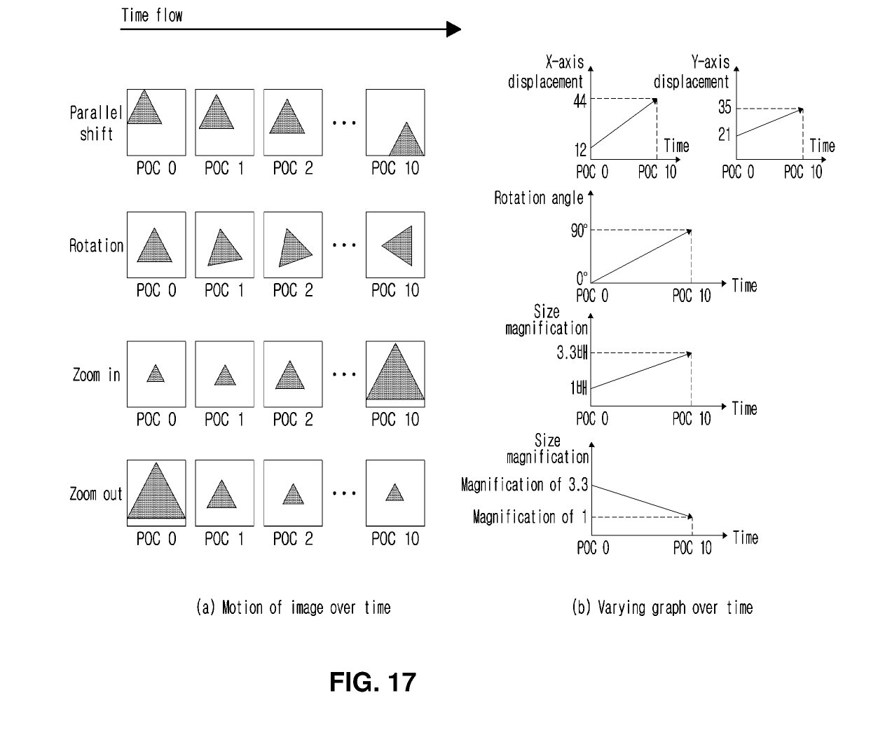

FIG. 17 is a view illustrating an example of motion of an image over time and a graph showing this.

Referring to FIG. 17, frames of a video have temporally high similarity because a recording time interval between frames of a video is very short. For example, the time interval between one frame and subsequent frame is 1/30 second for a 30 Hz video, 1/60 second for a 60 Hz video, and 1/120 second for a 120 Hz video. In order to support more realistic image, there is a tendency for the time interval between one frame and subsequent frame to decrease.

Since the global motion or the local motion in an image is limited under short time intervals, the global motion or the local motion in the image has a characteristic that the global motion or the local motion linearly changes when the time interval is short enough.

When the time interval of a video is not large and the global motion between particular frames is known using linear motion change between frames, a relevant global motion and a global motion between other frames having small time interval may be predicted. Here, the prediction method may vary depending on a method of representing a global motion. As a method of representing a global motion, there are a method using a two-dimensional motion vector, a method using a geometric transform matrix, a method using a numerical value indicating the physical meaning, etc.

Examples of global motion information prediction methods that may be used in each method are described below.

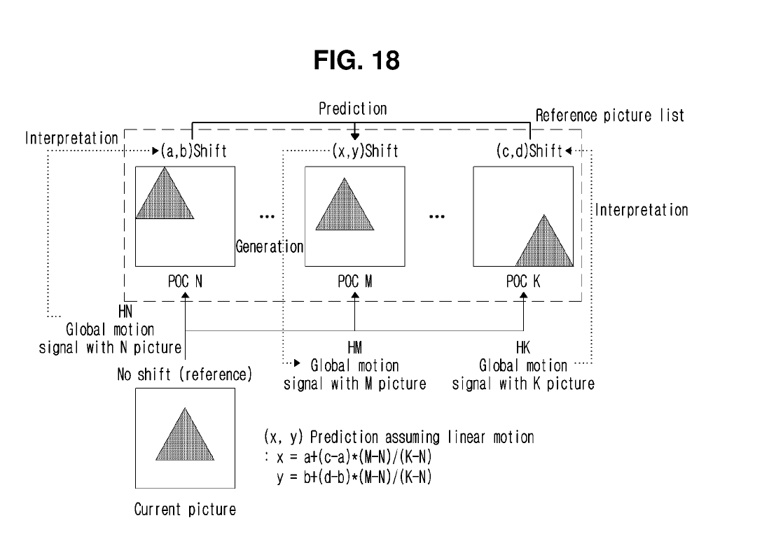

FIGS. 18 to 20 are views illustrating examples of global motion prediction methods for a linear global motion. FIGS. 18 to 20 show examples of methods of predicting an unknown global motion from a known global motion when a linear global motion occurs.

In FIGS. 18 to 20, HN means a signal indicating a global motion between a current picture and a POC N picture. HN means a signal indicating encoded global motion considering encoding efficiency, and also means a signal indicating single global motion as well as complex global motion. Similarly, the HM is a signal indicating a global motion between a current picture and POC M, and HK is a signal indicating a global motion between a current picture and POC K. Here, a global motion signal may be global motion information.

Therefore, each signal may be translated, partitioned, or decoded in a form suitable for global motion prediction. In FIGS. 18, 19, and 20, “interpretation” may mean a process of translating, partitioning, or decoding a signal representing a global motion in a form suitable for global motion prediction. Here, each global motion signal may be utilized directly without translation or partitioning.

In FIGS. 18 to 20, the global motion of POC M, which is an unknown value, is a prediction target, and may be predicted using POC N and POC K. Here, POC of a reference picture used in prediction and global motion information of a current picture are used, and POC of the current picture may be used depending on a prediction method and on the case.

FIG. 18 is a view illustrating an example of a global motion prediction method for linear parallel shift.

Referring to FIG. 18, a global motion signal HM for a reference picture POC M may be predicted based on global motion signals HN and HK of a reference picture POC N and a reference picture POC K.

Specifically, the global motion (a, b) for linear parallel shift of the reference picture POC N may be interpreted from HN, and the global motion (c, d) for linear parallel shift of the reference picture POC K may be interpreted from HK. The interpreted global motion may be used to predict the global motion (x, y) of a reference picture (POC M).

Here, prediction of the global motion (x, y) may be performed using the following formula 1.

x=a+(c−a)*(M−N)/(K−N), y=b+(d−b)*(M−N)/(K−N) [Formula 1]

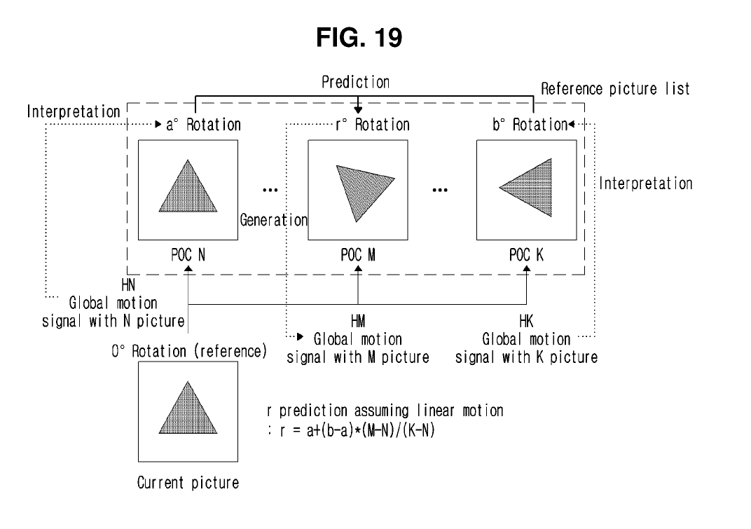

FIG. 19 is a view illustrating an example of a global motion prediction method for linear rotation shift.

Referring to FIG. 19, a global motion signal HM for a reference picture POC M may be predicted based on global motion signals HN and HK of the a reference picture POC N and a reference picture POC K.

Specifically, the global motion (a°) for linear rotation shift of the reference picture POC N may be interpreted from HN, and the global motion)(b°) for linear rotation shift of the reference picture POC K may be interpreted from HK. The interpreted global motion may be used to predict the global motion (r°) of the reference picture POC M.

Here, prediction of the global motion (r°) may be performed using the following formula 2.

r=a+(b−a)*(M−N)/(K−N) [Formula 2]

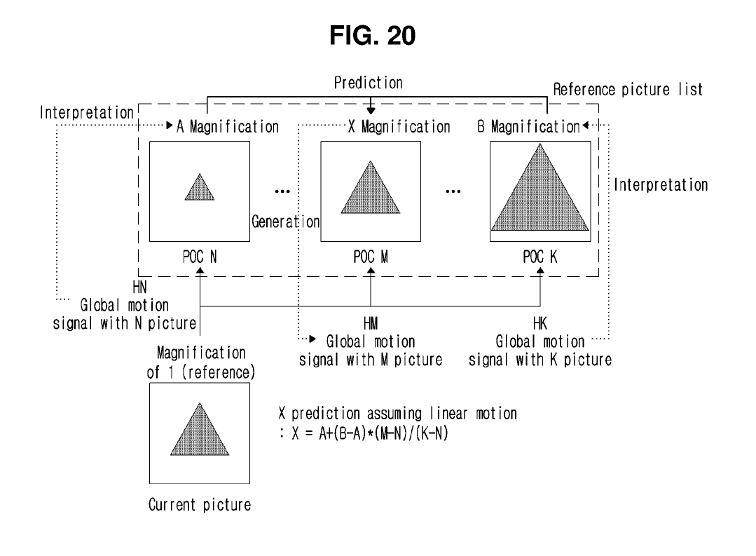

FIG. 20 is a view illustrating a global motion prediction method for linear scaling.

Referring to FIG. 20, a global motion signal HM for a reference picture POC M may be predicted based on global motion signals HN and HK of a reference picture POC N and a reference picture POC K.

Specifically, the global motion (magnification ratio A) for linear scaling of the reference picture POC N may be interpreted from HN, and the global motion (magnification ratio B) for linear scaling of the reference picture POC K may be interpreted from HK. The interpreted global motion may be used to predict the global motion (magnification ratio X) of the reference picture POC M.

Here, prediction of the global motion (magnification ratio X) may be performed using the following formula 3.

X=A+(B−A)*(M−N)/(K−N) [Formula 3]

The method for encoding an image and the method for decoding an image according to the present invention may predict global motion information by using at least one piece of local motion information.

The global motion information may be predicted from the local motion information of a reference frame used in encoding and decoding a current frame. When the reference frame contains only local motion information rather than global motion information, the global motion information may be predicted from the local motion information.

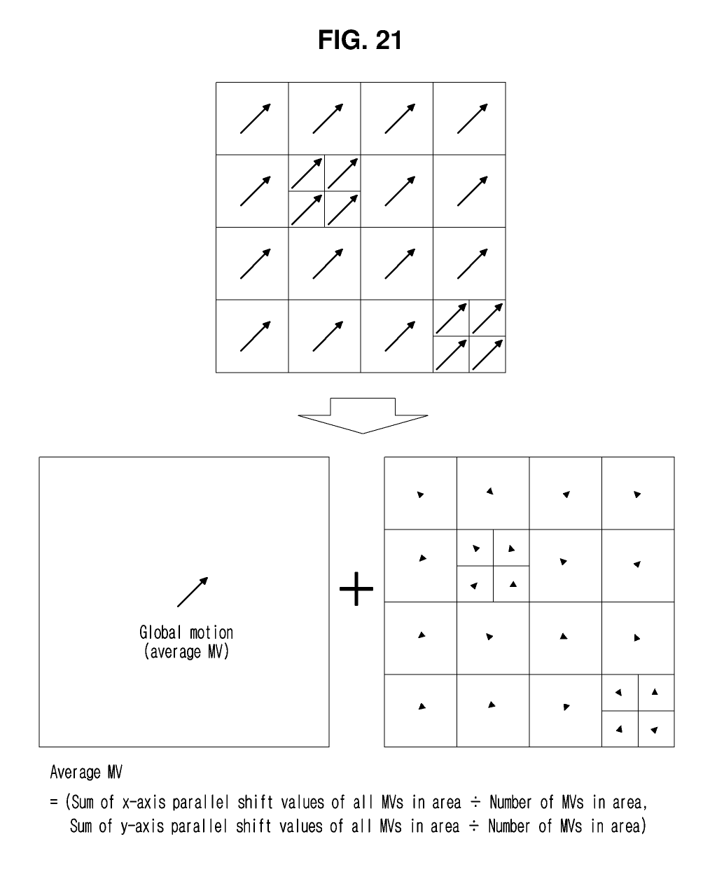

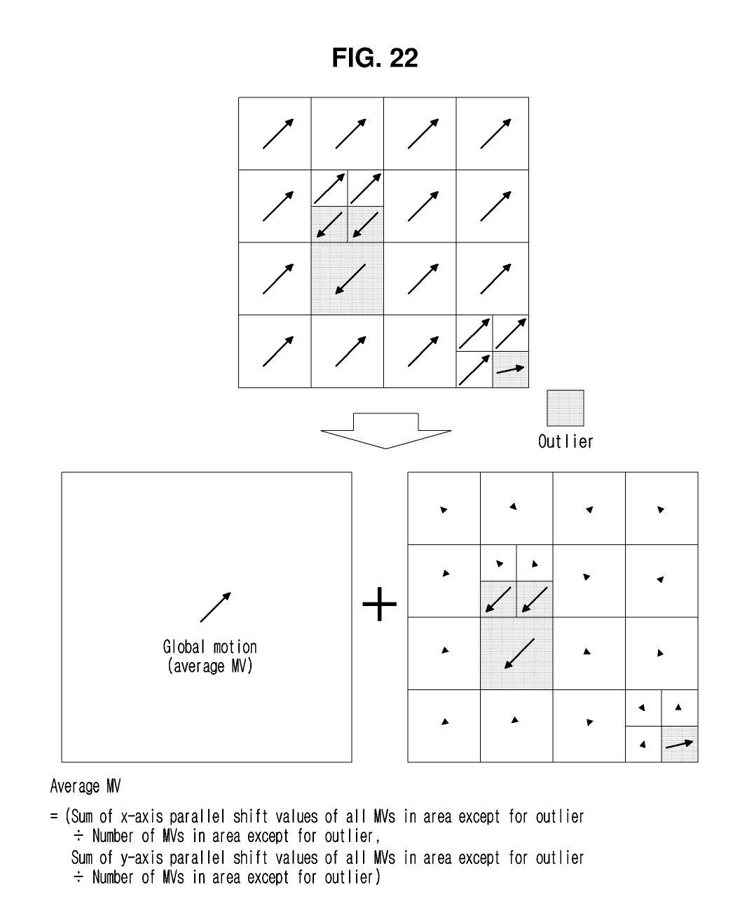

FIGS. 21 and 22 are views illustrating a method of predicting a global motion by parallel shift from local motions represented by two-dimensional vectors.

FIG. 21 shows an embodiment of predicting global motion information from local motion vectors for all areas of a picture. Specifically, an average of local motion vectors for all areas of the picture may be set as a prediction value of a global motion vector.

Similar to FIG. 21, in FIG. 22, the global motion vector is predicted using the average of local motion vectors, but an average of selected local motion vectors is used rather than the average of local motion vectors for all areas of the picture. The process of selecting local motion vectors may be performed by excluding the local motion that deviates from the tendency of the local motion of the whole picture. In the global motion prediction method of FIG. 22, since whole motion is not used in calculation, computational complexity and the use of memory resources can be reduced.

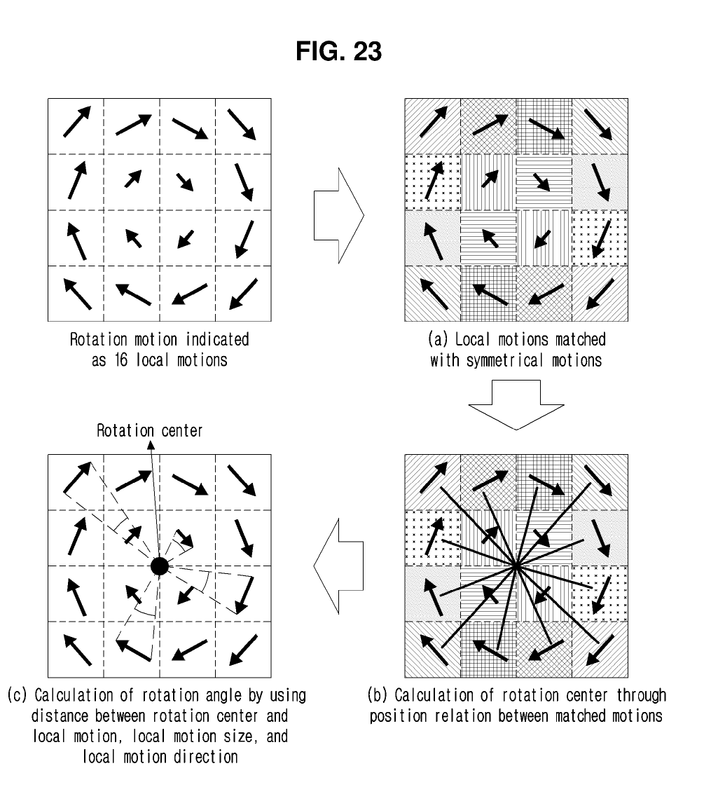

FIGS. 23, 24, and 25 are views respectively illustrating methods of predicting global motion by rotation shift, zooming in, and zooming out. In FIGS. 23 to 25, rotation shift, zoom-in motion, and zoom-out motion may be represented by two-dimensional vectors.

When rotation shift, zooming in, and zooming out are represented by local motions of two-dimensional vectors, there may be a limit to predict a global motion using the average of local motions. Therefore, a method of predicting global motion information may be used considering a position relation of each piece of local motion information in a reference frame.

For example, in the case of rotation shift, as shown in FIG. 23, since point symmetry is based on the center of rotation, the center of rotation and rotation angle may be predicted considering the direction, the size, and the position relation of the local motion information.

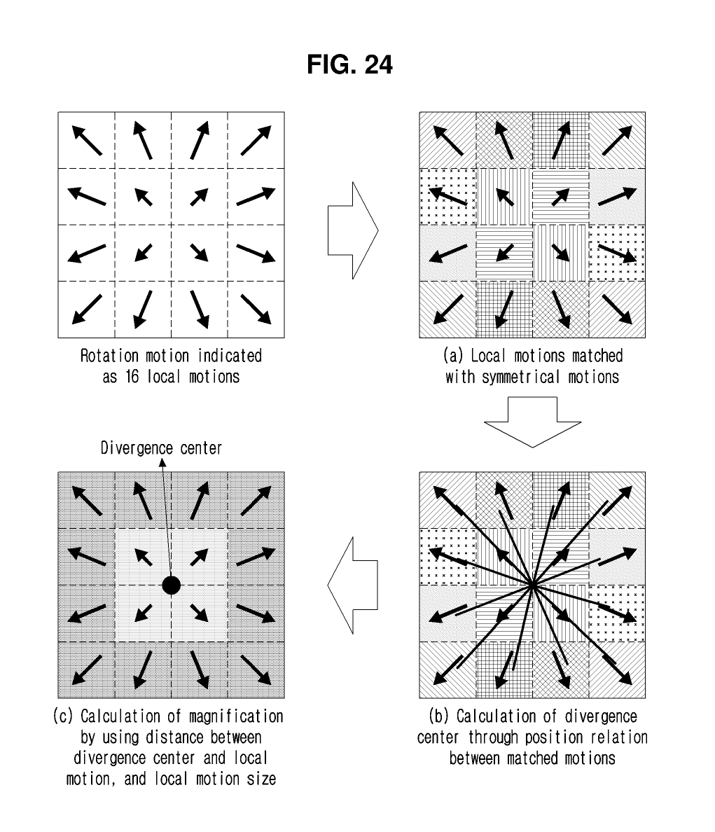

In the case of zooming in, as shown in FIG. 24, since two-dimensional vectors indicating local motions are divergent around a particular position, the center of zooming in and the degree of zooming in may be predicted considering the direction, the size, and the position relation of the local motion information.

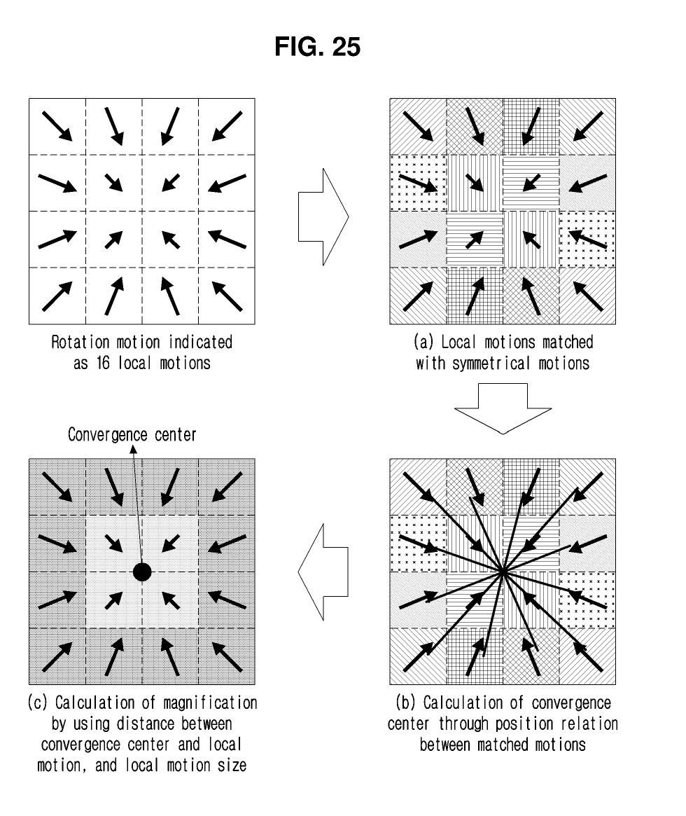

In the case of zooming out, as shown in FIG. 25, since two-dimensional vectors indicating location motions indicating local motions are convergent around a particular position, the center of zooming out and the degree of zooming out may be predicted considering the direction, the size, and the position relation of the local motion information.

In an embodiment of predicting the global motion or rotation, zooming in, and zooming out, as shown in FIGS. 23(a), 24(a), and 25(a), pairs of pieces of local motion information having similar size and pointing in opposite directions are generated. As shown in FIGS. 23(b), 24(b), and 25(b), the center point of the positions of each pair of pieces of information is found and similarity of the center points is identified to check the tendency, whereby the center point can be found.

In the case where the center point is identified, when a pair of pieces of local motion information points in the center point direction, it may be determined as having the tendency to zoom out, and when pointing in opposite directions to the center point, it may be determined as having the tendency to zoom in, and when pointing in directions perpendicular to the center point direction, it may be determined as having the tendency to rotate.

In the case of zooming in and zooming out, as shown in FIGS. 24(c) and 25(c), the size of zooming in or zooming out may be calculated considering scaling of the local motion vector depending on the distance from the center point.

In the case of rotation, as shown in FIG. 23(c), the rotation angle may be calculated using the motion vector size based on the center point.

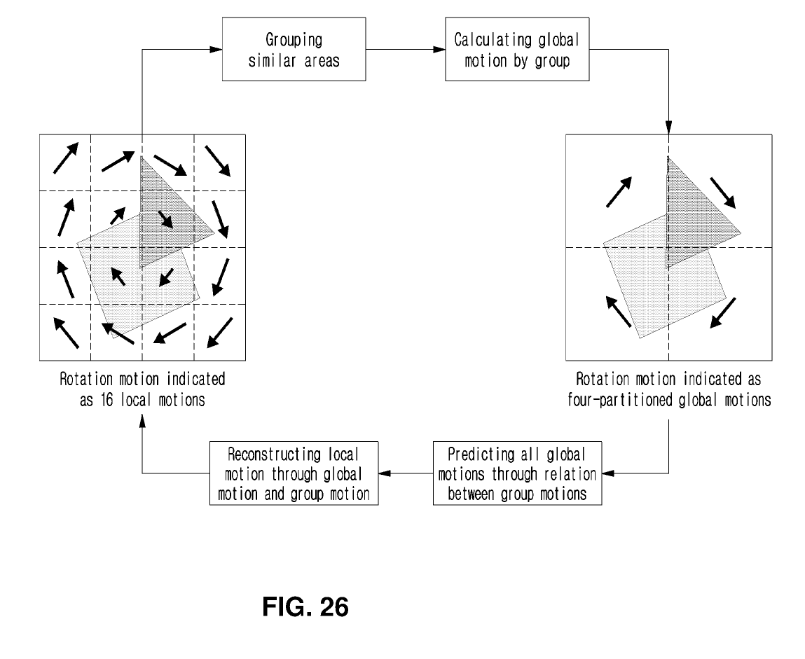

Also, as shown in FIG. 26, areas having similar local motions are grouped and the global motion may be represented for each area.

Referring to FIG. 26, rotation motions indicated as 16 local motions may be grouped into similar areas having similar rotation directions. 16 areas may be grouped into four similar areas, since four upper left areas, four upper right areas, four lower left areas, and four lower right areas have respective similar rotation directions. For each similar area, the global motion may be calculated for each group, and the global motion for each group may be used to predict the global motion for all areas.

In the meantime, the grouping method shown in FIG. 26 and methods described in FIGS. 23, 24, and 25 may be used in combination.

The calculated global motion information of rotation, zooming in, and zooming out may be represented by a geometric transform matrix, a numerical value indicating the physical meaning, or a pre-defined symbol.

One method of representing a global motion is to use a two-dimensional vector. An image having a global motion by parallel shift may have the reduced number of bits required for representation by representing the global motion by a two-dimensional vector, and may be easily merged with or separated from the local motion represented by a two-dimensional vector.

Motion is represented by a two-dimensional vector using displacement in two directions horizontal and vertical, and linearly changes between frames having short time intervals. Therefore, as shown in FIG. 18, global motion information may be predicted by weighted averaging a displacement value of each axis depending on time intervals.

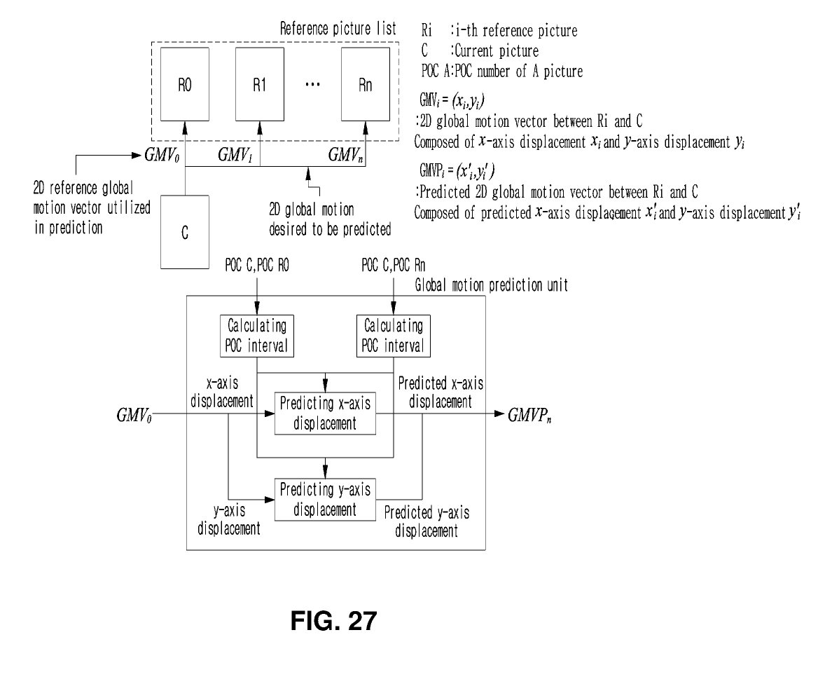

FIG. 27 is a view illustrating an example of a method of predicting global motion information represented by a two-dimensional vector.

FIG. 27 shows a method of predicting a global motion using a global motion of a neighbor reference picture as described in FIG. 18.

Referring to FIG. 27, in order to predict a global motion vector GMVn of a reference picture Rn, at least one of a global motion vector GMV0 of a reference picture R0 and a global motion vector GMV1 of a reference picture R1, and a POC interval between the current picture and a reference picture of a global motion vector used in prediction may be used. Here, one or multiple reference global motion vectors may be used in prediction.

The POC interval may be one of a POC interval between the current picture and the reference picture, a POC interval between a reference picture of the current picture and the third reference picture of the current picture, and a POC interval of a reference picture of a reference picture of the current picture. Here, the third reference picture may mean one of multiple reference pictures for the current picture.

Also, when the global motion vector is represented as multiple two-dimensional vectors, global motion vector prediction may be used for all or part of multiple two-dimensional vectors.

One method of representing a global motion is to use a geometric transform matrix. The geometric transform matrix may differ depending on type of represented motion, and various motions, such as parallel shift, rotation, zooming in, zooming out, perspective transformation, etc., may be represented in a complex manner. The size and shape of the geometric transform matrix may differ depending on the number of used variables.

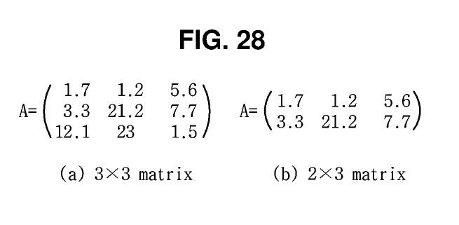

FIG. 28 is a view illustrating examples of a geometric transform matrix depending on size.

Since the geometric transform matrix is represented by a combination of various motions, the geometric transform matrix may be somewhat limited to be decomposed and utilized for each motion.

Also, in the case of rotation motion among combined motions, even though a rotation angle linearly changes, the value representing rotation motion through the cosine or sine function does not linearly change. Due to the characteristics, a value of the geometric transform matrix is likely to have non-linear characteristics, and thus it is difficult to predict the value using a linear prediction method. Therefore, in order to predict a global motion represented by a geometric transform matrix, the following methods may be used.

Method 1. A Global Motion Prediction Method Using Interpolation

Interpolation is used as a technique for predicting the characteristics of a function using multiple sets of a pair of a displacement x and a result value y of a function according to x, and for predicting a result value y′ of an unknown displacement x′.

As interpolation, there are linear interpolation, polynomial interpolation, spline interpolation, etc.

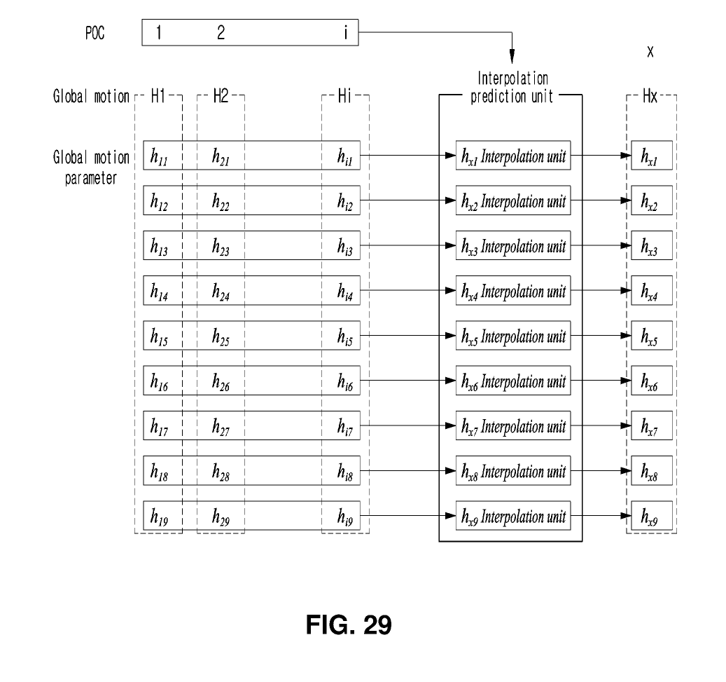

When predicting global motion information using interpolation, the POC (Picture Order Count) number, which is the time axis order in a video of a reference frame, is the displacement x, and a global motion relation with a current encoding and decoding frame depending on each POC number corresponds to the result value y. Here, each parameter of the geometric transform matrix may be predicted using interpolation for each parameter as shown in FIG. 29.

FIG. 29 is a view illustrating an example of interpolation for each parameter of motion information.

Referring to FIG. 29, each POC of a reference frame has a global motion that may be represented as n parameters (global motion parameters). Here, since interpolation is performed predicting change of each parameter in consequence of POC change, interpolation may be performed between parameters of the same series. For example, the global motion may be represented as nine parameters as shown in FIG. 29.

In the meantime, when used global motion information is linear, linear interpolation may be used. This is the same as the prediction method using the weighted average used in predicting motion information represented by a two-dimensional motion vector.

Since global motion information represented by a geometric transform matrix has the non-linear characteristics, a high degree of interpolation, such as polynomial interpolation, spline interpolation, etc. is required to be used for accurate prediction.

However, a large number of pairs of the displacement x and the result value y may be required for more accurate prediction. In encoding and decoding an image, the number of pieces of global motion information included in a reference frame of a current encoding and decoding frame may not be suitable for a high degree of interpolation.

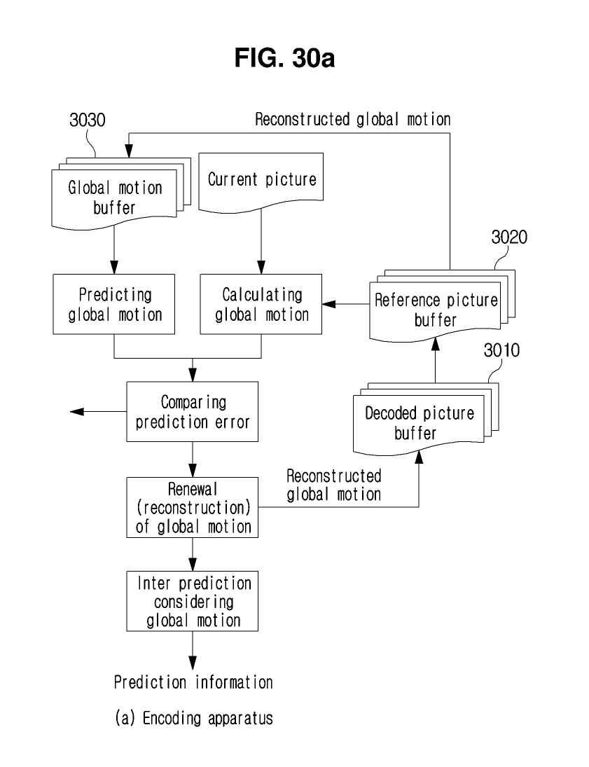

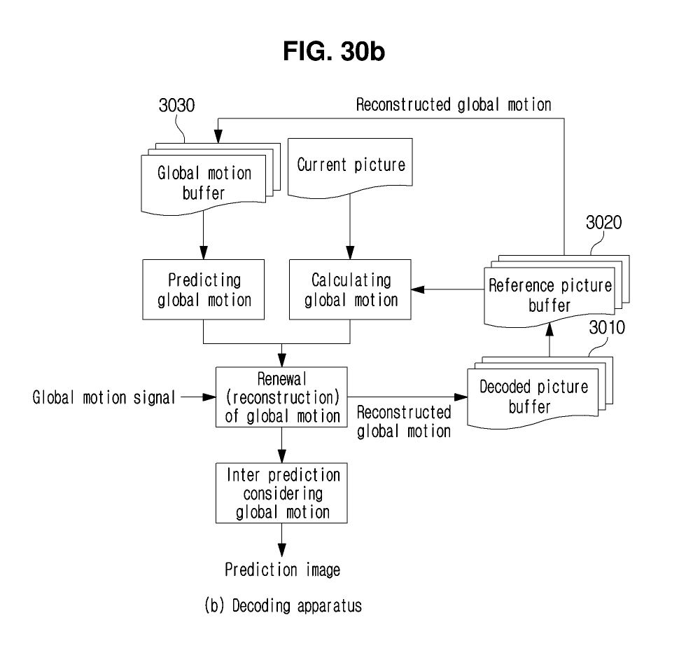

FIG. 30 is a view illustrating an example of an encoding apparatus and a decoding apparatus using reconstructed global motion information in global motion prediction, being limited to a current reference picture buffer. In FIG. 30, the global motion information used in global motion prediction may be limited to a reference picture in a reference picture list of a current reference picture list and global motion of a current picture.

Referring to FIGS. 30a and 30b, the encoding apparatus and the decoding apparatus manages reconstructed global motion information with a reconstructed picture in a decoded picture buffer 3010. A reference picture buffer 3020 is configured using some or all of reconstructed pictures and only the reconstructed global motion information therein may be assigned to a global motion buffer 3030 for global motion prediction.

In this case, global motion information (global motion prediction candidate) that may be used for global motion prediction is small, and thus prediction accuracy may be low. The global motion information is accumulated and stored to be used such that the number of global motion prediction candidates may be increased and prediction accuracy may be enhanced. Also, prediction accuracy may be enhanced using both global motion information included in the reference frame of the current frame and global motion information included in a reference frame of a previously decoded frame.

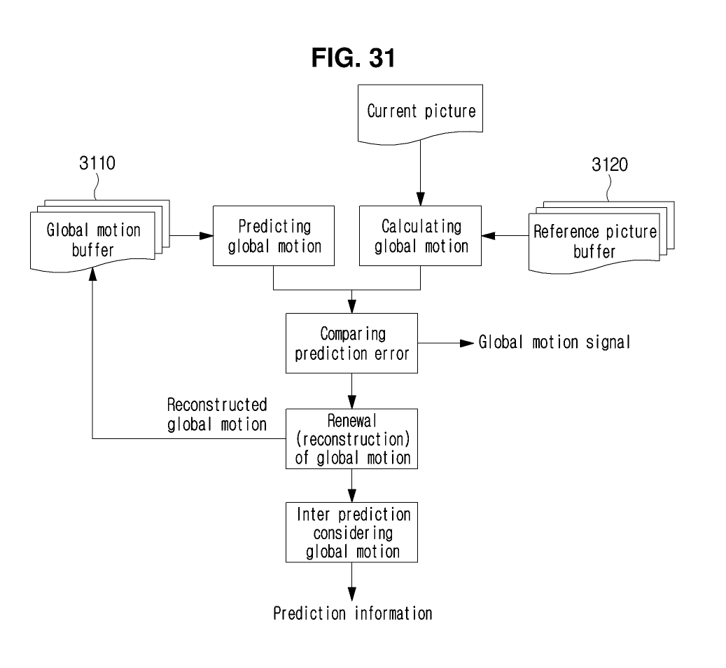

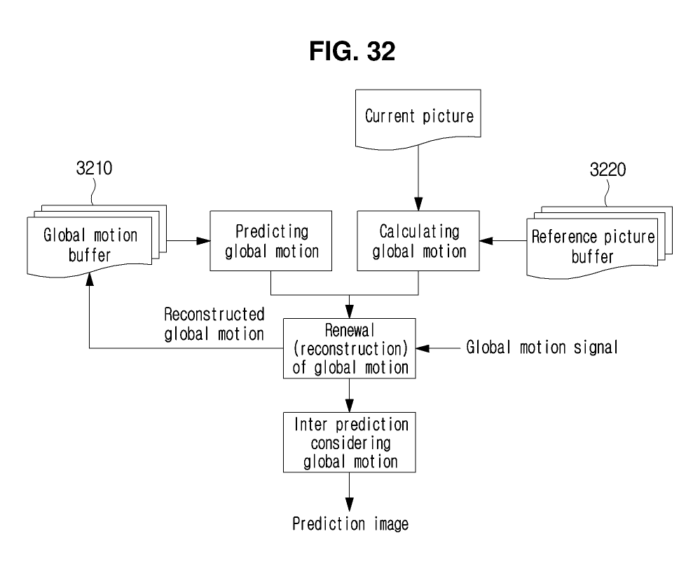

FIGS. 31 and 32 are views illustrating examples of an encoding apparatus and a decoding apparatus continually accumulating and using global motion information included in a reconstructed reference frame for global motion prediction.

In FIGS. 31 and 32, the encoding apparatus and the decoding apparatus may continually accumulate and store the reconstructed global motion information global motion buffers 3110 and 3210 rather than reference picture buffers 3120 and 3220.

The global motion information in the global motion buffers 3110 and 3210 may be used in global motion prediction. Here, the global motion information in the global motion buffers 3110 and 3210 may include the POC number of a standard picture to restore, the POC number of a reference picture having a global motion relation with a standard picture, and information indicating global motion between two pictures.

In global motion prediction, a current picture, which is a current decoding target picture, and a standard picture with a global motion in the global motion buffer may have different POC, and thus correction may be required therefor.

In the meantime, when continually accumulating and using global motion information in global motion prediction, more accurate global motion prediction can be expected. However, continued accumulation may lead to excessive use of memory resources of the buffer. Also, when the error occurs in the middle of the process, there is a concern that the error may be continuously propagated to the prediction.

Therefore, the appropriate number of global motions may be accumulated to be used and then refreshed.

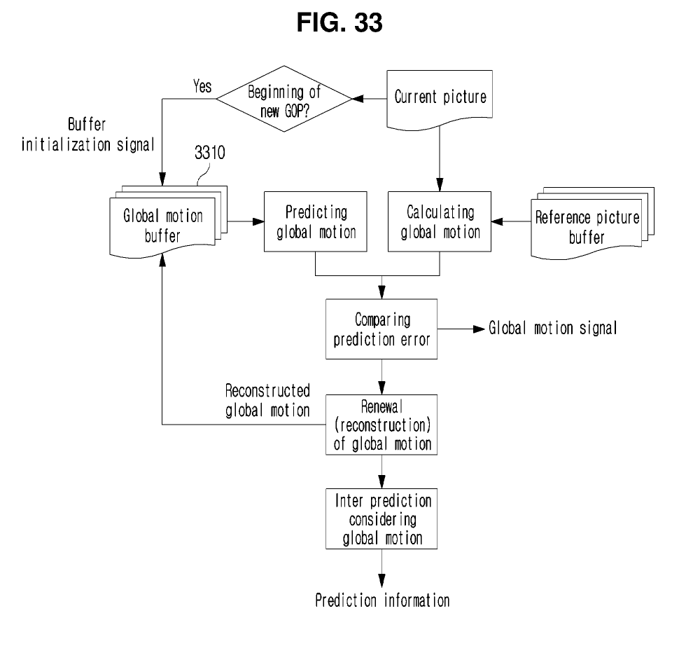

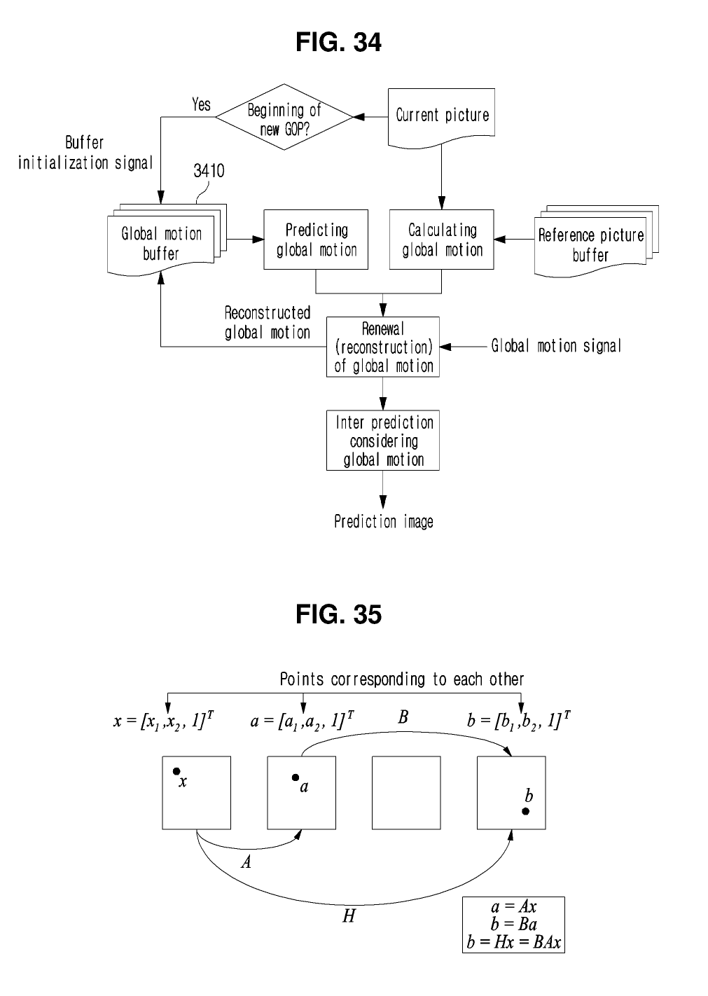

FIGS. 33 and 34 are views illustrating examples of an encoding apparatus and a decoding apparatus accumulating reconstructed global motion information in units of a GOP to be used in global motion prediction.

Referring to FIGS. 33 and 34, when a current picture is a picture that is the beginning of a new GOP, the global motion buffers 3310 and 3410 may be initialized to refresh the accumulation of reconstructed global motion information. That is, reconstructed global motion information is accumulated in units of a GOP to be used in global motion prediction.

Method 2. A Global Motion Prediction Method by Matrix Multiplication

FIG. 35 is a view illustrating an example of a global motion prediction method by matrix multiplication.

Referring to FIG. 35, a geometric transform matrix transforming x into a is designated as A, and a geometric transform matrix transforming a into b is designated as B. A geometric transform matrix transforming x into b is designated as H.

In FIG. 35, when the geometric transform matrix H is required to be predicted, H is equal to the matrix multiplication BA of B and A. When applying global motion prediction thereto, x means a point included in a current encoding and decoding frame, and a means a point included in a frame temporally different from the frame including x, the point a corresponding to the point x. Here, b is a point in a frame different from the frame including x and the frame including a, and means a point corresponding to x and a. A is a geometric transform matrix that means global motion information between the frame including x and the frame including a. When the global motion A is applied to x, x can find the position of the corresponding point a. B is a geometric transform matrix that means global motion information between the frame including a and the frame including b. When the global motion B is applied to a, a can find the position of the corresponding point b. H is a geometric transform matrix that means global motion information between the frame including x and the frame including b. When the global motion H is applied to x, x can find the position of the corresponding point b.

Here, the global motion represented by a geometric transform matrix is applied by multiplying the geometric transform matrix indicating the global motion and a matrix indicating the position of a point. As a result thereof, a matrix indicating the position of the corresponding point may be obtained. The matrix H indicating the global motion is equal to the product of two geometric transform matrices B and A. Thus, when two geometric transform matrices B and A are known, the matrix H can be obtained.

Using the method described in FIG. 35, global motion information may be predicted based on the reference picture and global motion information of the reference picture of the reference picture.

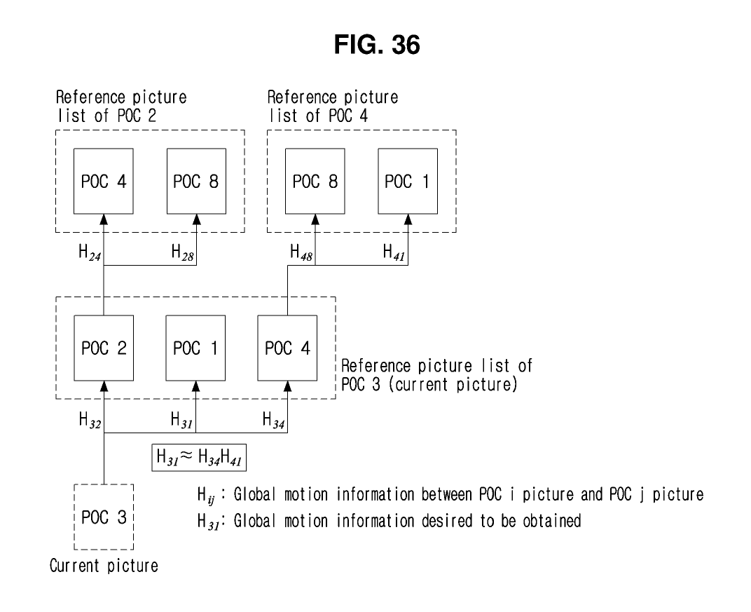

FIG. 36 is a view illustrating an example of a method of predicting global motion information by performing multiplication of a geometric transform matrix.

FIG. 36 shows a method of predicting a geometric transform matrix H31 indicating global motion information of the current picture POC 3 and the reference picture POC 1. Referring to FIG. 36, the POC 3 uses the POC 4 as a reference picture, and the POC 3 has a global motion relation of H34 with the POC 4. The POC 4 uses the POC 1 as a reference picture, and the POC 4 has a global motion relation of H41 with the POC 1.

In this case, H31 is the matrix multiplication of H34 and H41, and may be predicted. Unlike FIG. 26, when the POC 4 does not uses the POC 1 as a reference picture, the case where the POC 1 is used as a reference picture among reference pictures of the POC 3 is searched for, or the reference picture of the POC 3 and the global motion of the POC 1 are predicted and utilized.

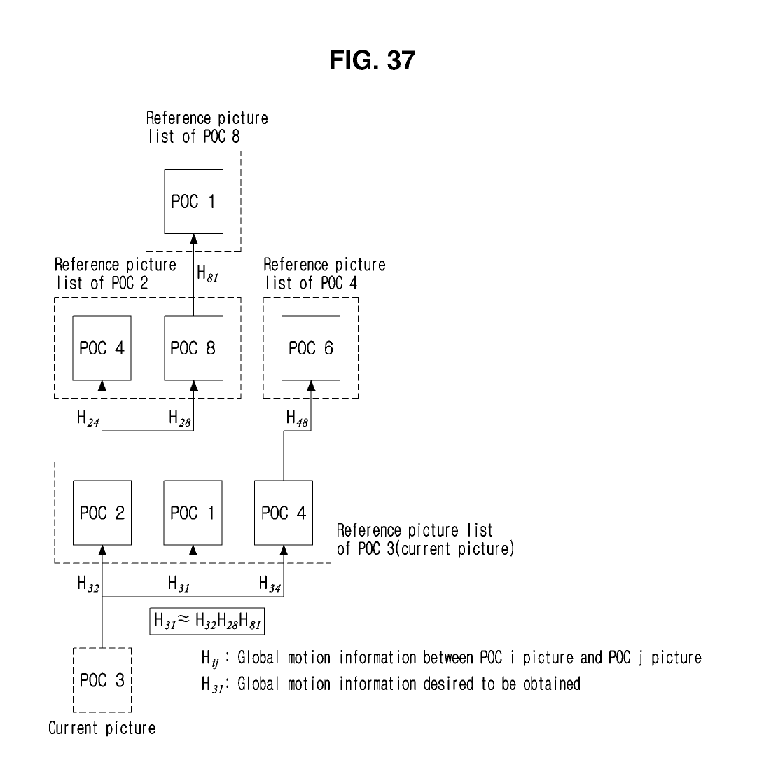

FIG. 37 is a view illustrating an example of a method of predicting global motion information by performing multiplication of multiple geometric transform matrices.

Referring to FIG. 37, since there is no POC 1 in the reference picture of the reference picture of the current picture, it is impossible to generate the geometric transform matrix H31 required to be predicted multiplying two geometric transform matrices. However, since the POC 1 exists in the reference picture of the POC 8 which is one of reference pictures of the reference picture, it is possible to generate the geometric transform matrix H31 required to be predicted multiplying successive geometric transform matrices.

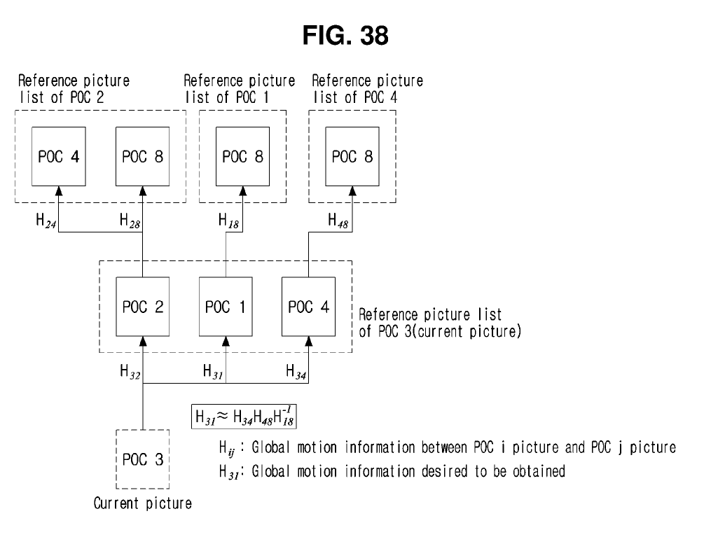

FIG. 38 is a view illustrating an example of a method of predicting global motion information by performing multiplication of a geometric transform matrix and a geometric transform inverse matrix. FIG. 38 shows the case where it is impossible to generate the geometric transform matrix H31 required to be predicted even by using a reference relation since there is no reference picture referring to the POC 1.

However, since the POC 1 refers to the POC 8, the geometric transform matrix H18 representing a global motion is known. Also, a reference picture referring to the POC 8 exists. Thus, after generating the geometric transform matrix multiplication until the POC 8, the geometric transform matrix from the POC 8 to POC 1 is multiplied by calculating the inverse matrix of H18 so as to predict H31. As described above, the inverse matrix may be utilized. Here, in prediction through multiplication of the geometric transform matrix, a geometric transform matrix between a reference picture and a reference picture of a reference picture as well as a geometric transform matrix of a reference picture and a current picture may be used.

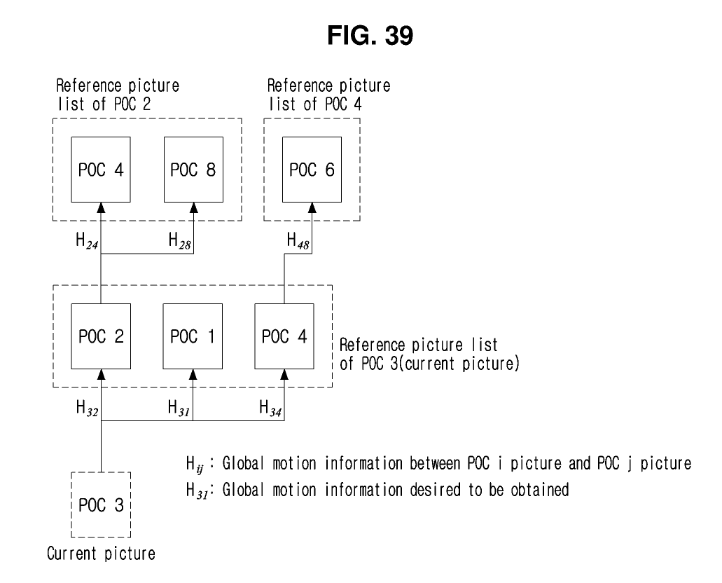

FIG. 39 is a view illustrating an example where a global motion cannot be predicted directly by geometric transform matrix multiplication.

In FIG. 39, it is impossible to generate H31 directly by the method using matrix multiplication. However, since there are a large number of geometric transform matrices, a geometric transform matrix between pictures that do not exist in the current picture and the reference picture of the current picture may be indirectly generated using multiplication of the geometric transform matrices. Using the generated reference picture, the number of candidates utilized in FIGS. 36 to 38 may be increased. Thus, prediction accuracy in FIGS. 36 to 38 may be enhanced.

Method 3. A Prediction Method by Linear Prediction

Global motion information represented by a geometric transform matrix has a non-linear change, but linear prediction is possible. Prediction efficiency may be lower than other methods, but it may be better than not performing prediction. Also, linear characteristics may be reconstructed by converting the value of the geometric transform matrix into a two-dimensional motion vector or a numerical value indicating the physical meaning.

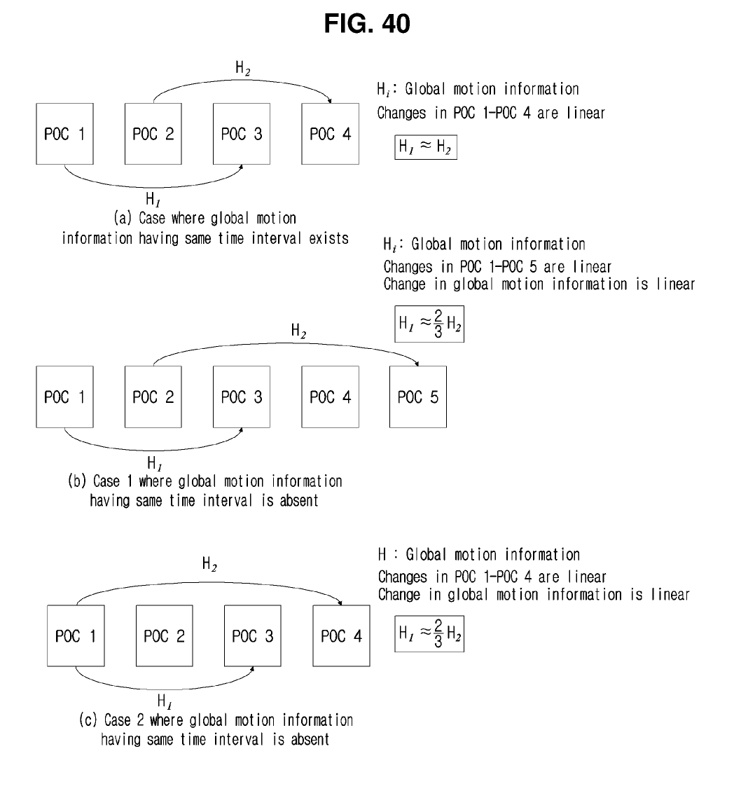

FIG. 40 is a view illustrating an example of a method of predicting global motion information using linear prediction.

Prediction may be performed assuming a linear change by considering the temporal interval or POC interval at which a global motion occurs and parameter changes of a geometric transform matrix depending on the time interval.

Referring to FIG. 40(a), the POC interval between the POC 1 and POC 3 is a value of 2, and has a geometric transform matrix H1 representing a global motion. The POC interval between the POC 2 and POC 4 is a value of 2, and has a geometric transform matrix H2 representing a global motion. Here, when a linear global motion occurs between the POC 1 to POC 4, it may be predicted that the same global motion has the same POC interval.

Therefore, when H1 is required to be predicted and H2 is known, it may be predicted that H2 is similar to H1 and H2 may be predicted as H1.

In FIG. 40(b), when H1 is required to be predicted, unlike FIG. 40(a), global motion information having the same POC interval is unknown.

Referring to FIG. 40(b), H2 is global motion information between the POC 2 and POC 5, and is a global motion for the POC interval of 3. When a linear global motion occurs between the POC 1 to POC 5, the change rate of the global motion per POC interval of 1 may be the same. H1 indicating global motion change of the POC interval of 2 may indicate global motion change of ⅔ of global motion change of the POC interval of 3.

Accordingly, when H2 and H1 linearly represent the global motion, H1 may be ⅔ of H2.

In the meantime, the value of the geometric transform matrix may not be linearly represented. However, under the small time intervals, when the value change of the geometric transform matrix is small, linear motion may be assumed and prediction may be performed. Also, when global motion information represented by a geometric transform matrix is represented by a linear two-dimensional vector or a linear physical equation, linear prediction may be possible.

Unlike the case of FIG. 40(c), global motion prediction may be performed using the global motion for different POC intervals from pictures with the same POC number. In this case, like the case of FIG. 40(b), prediction may be performed considering the change rate of the POC interval.

Method 4. A Prediction Method Using a Unit Matrix

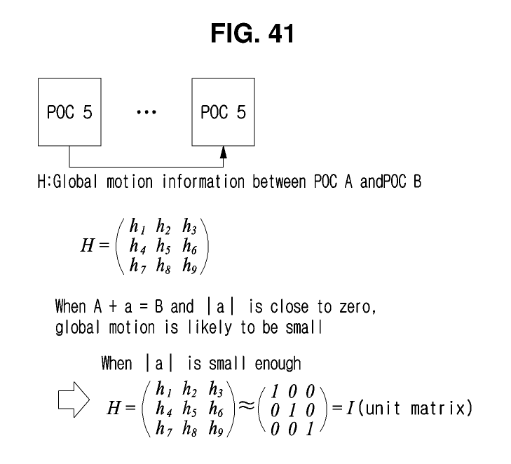

FIG. 41 is a view illustrating an example of a method of predicting global motion information using a unit matrix.

The above-described Method 1, Method 2, Method 3, and Method 4 may be used when there is global motion information which is a candidate to be used in prediction. When there is no candidate to be used in prediction or when the global motion is absent or small enough, a unit matrix may be used to perform prediction. In the geometric transform matrix representing the global motion, the unit matrix means no motion. In a video, the global motion between pictures having a sufficiently short time interval is generally small. Thus, the geometric transform matrix representing the global motion is likely to be similar to the unit matrix. Accordingly, the unit matrix indicating no motion is used to perform prediction, such that encoding efficiency may be enhanced.

In the meantime, some or all of the above-described Method 1, Method 2, Method 3, Method 4,and other methods of predicting global motion information may be selected and used in combination. Also, when multiple methods are used, the same prediction method is required to be used so as to prevent inconsistency between the encoder and the decoder. Thus, a signal (or information) indicating which method is used may be included in the bitstream.

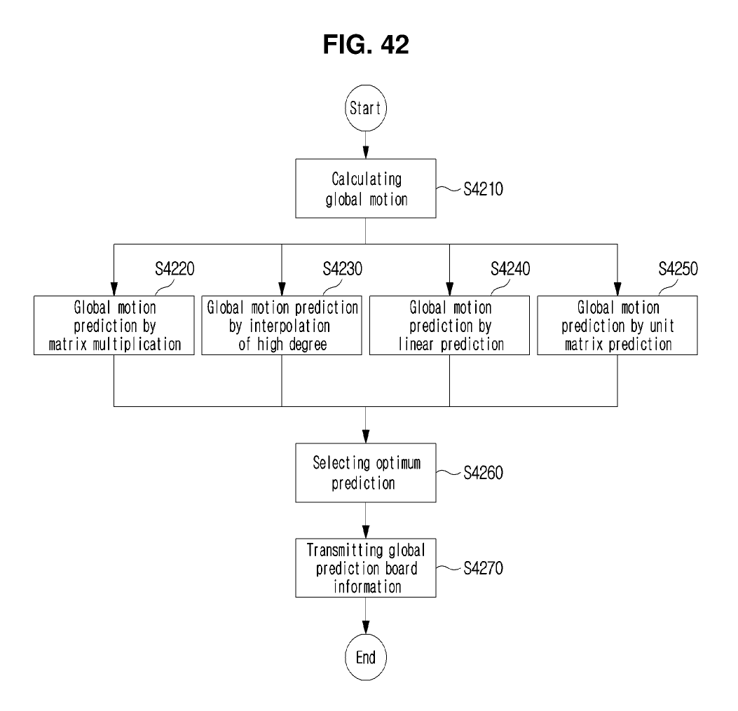

FIG. 42 is a view illustrating an example of, as the case where all global motion prediction method of Method 1, Method 2, Method 3, and Method 4 are applied, a method of selecting an optimum prediction method and transmitting information on which prediction method is used to a decoder.

Referring to FIG. 42, the global motion may be calculated at step S4210, prediction global motion information may be obtained using global motion prediction by matrix multiplication at step S4220, global motion prediction by a high degree of interpolation at step S4230, global motion prediction by linear prediction at step S4240, and global motion prediction using a unit matrix at step S4250. The prediction global motion information obtained by respective prediction methods is compared with the calculated global motion at step S4210 so as to select the optimum prediction method at step S4260. Global prediction mode information indicating the optimum prediction method may be transmitted at step S4270.

When transmitting the global prediction mode information (or selection information of the method of predicting global motion information), additional bits are required, and thus encoding efficiency may be degraded. Therefore, in encoding and decoding, by selectively using the same method through the same criteria and process, the bitstream may be used without including the global prediction mode information.

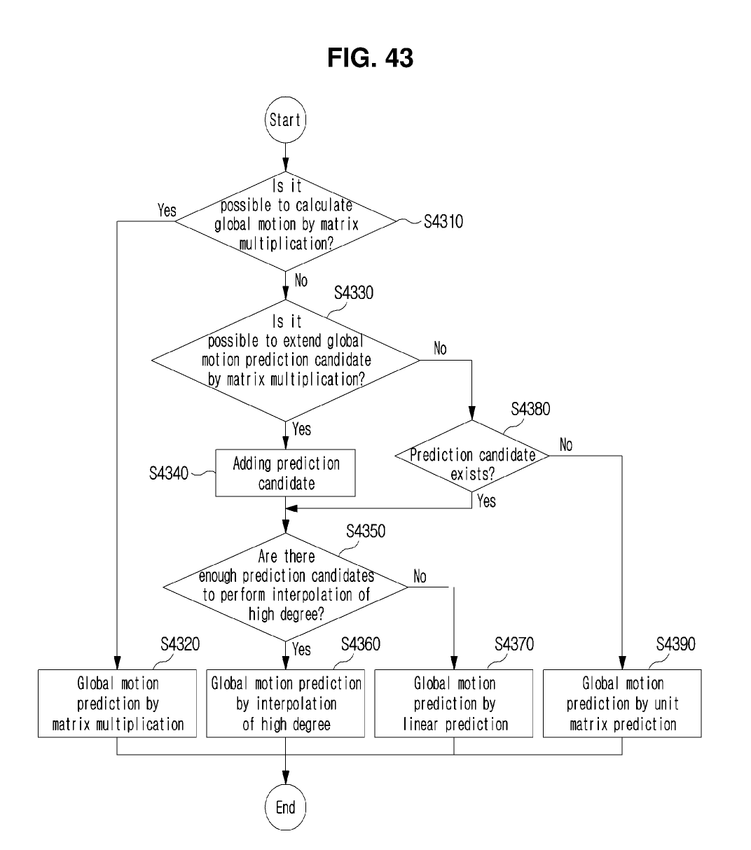

FIG. 43 is a view illustrating an example of, with a particular criterion, an encoding apparatus and a decoding apparatus selecting and using the same prediction method without transmitting and receiving additional information.

Referring to FIG. 43, first, when determining that it is possible to calculate the global motion by matrix multiplication at step S4310-Yes, global motion prediction by matrix multiplication may be performed at step S4320. For example, it may be determined that calculating of the global motion by matrix multiplication is possible in the cases of FIGS. 36 to 38, and is impossible in the case of FIG. 39.

When determining that it is impossible to calculate the global motion by matrix multiplication at step S4310-No, and determining that it is possible to extend a global motion prediction candidate by matrix multiplication at step S4330-Yes, a global motion prediction candidate may be added at step S4340. When determining that there are enough prediction candidates to perform a high degree of interpolation at step S4350-Yes, global motion prediction by a high degree of interpolation may be performed using the added global motion prediction candidate at step S4360. In contrast, when determining that there are insufficient prediction candidates at step S4350-No, global motion prediction by linear prediction may be performed at step S4370. When determining that it is impossible to extend a global motion prediction candidate by matrix multiplication at step S4330-No, and determining that there is no global motion prediction candidate at step S4380-No, global motion prediction by unit matrix prediction may be performed at step S4390. In contrast, when determining that there is a global motion prediction candidate at step S4380-Yes, step S4350 may be performed.

Image shift or motion may be represented by a physical numerical value. For example, rotation may be represented by a rotation angle, parallel shift may be represented by a two-dimensional vector, and zooming in and zooming out may be represented by a magnification ratio. Therefore, complex motion of an image may be represented complexly using a physically represented numerical value.

Here, a numerical value indicating each shift may be linearly represented, and thus prediction may be performed using the weighted average (linear interpolation) depend on the POC interval. Examples in FIGS. 18, 19, and 20 respectively show methods of predicting numerical values indicating physical meanings for parallel shift, rotation angle, and zooming in and out through linear interpolation depending on the POC interval.

Hereinafter, a method of predicting global motion information of a multi-channel image will be described. Generally, a color image may contain multiple channels. For example, the RGB image has three channels of red, green, and blue, and has a brightness value for each color image.

YUV (YCbCr) image is composed of a channel having a luma signal and a channel having two types of chroma signals.

HSI image is composed of three channels of color, saturation, and brightness.

When each channel of an image is represented by the same resolution, the global motion of a video occurs regardless of the channel. Therefore, global motion information of one channel may be used by being predicted or derived from the global motion of another channel. Thus, it is unnecessary to transmit global motion for each channel such that encoding efficiency can be enhanced.

Like the 4:2:0 YUV image that is generally used in encoding and decoding a video, the resolution of a channel image having relatively low importance may be lowered more than the resolution of a channel image having relatively high importance. For example, in a 4:2:0 YUV image, the global motion of a chroma image may be predicted to be ½ of the global motion of a luma image.

Based on whether or not resolution between channels is the same and/or the resolution difference, the global motion of one channel may be predicted from global motion information of another channel. As described above, when the resolution of the image is different for each channel, the global motion information may be predicted and used considering the resolution ratio.

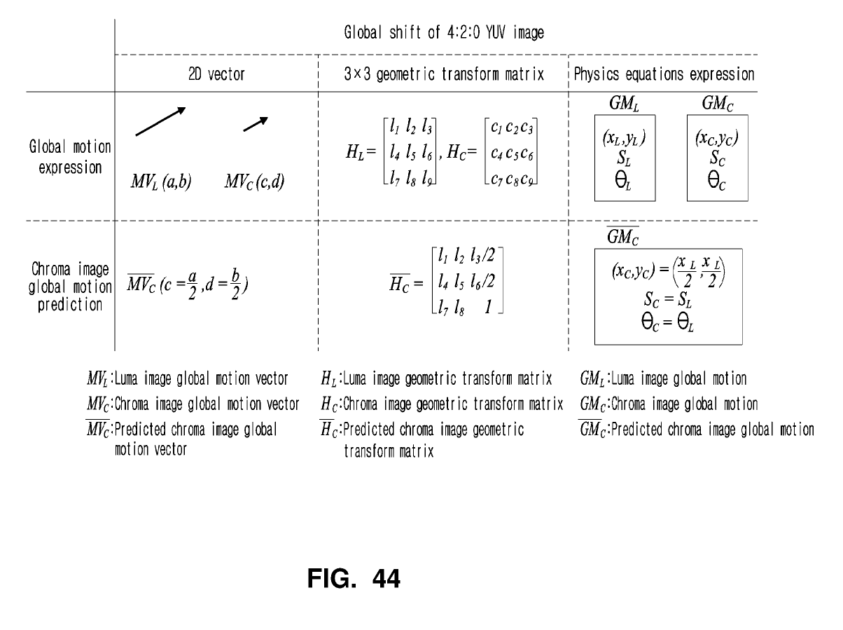

FIG. 44 is a view illustrating an example of a global motion prediction method for a chroma image.

FIG. 44 shows a global motion prediction method for each chroma image when the global motion is represented by a two-dimensional vector, a 3×3 geometric transform matrix, and a physics equation.

In the meantime, like a 4:4:4 YUV image or RGB image, when the resolution of all channels are the same, global motion information of only one channel is calculated and the global motion of another channel may be predicted as having the same global motion thereof.

Hereinafter, a method of using predicted global motion information will be described.

There are two methods for using predicted global motion information. The first method is using predicted global motion information as reconstructed global motion information without transmitting additional global motion information and the second method is transmitting the difference between predicted global motion information and original global motion information so as to reduce the amount of information to be transmitted.

Method 1. Only Using Predicted Global Motion Information Without Transmitting Additional Global Motion Information (a residual non-transmission mode)

When accuracy of the prediction signal is sufficiently high or omitting transmission of global motion information is better than enhancing accuracy, predicted global motion information is only used to enhance encoding efficiency.

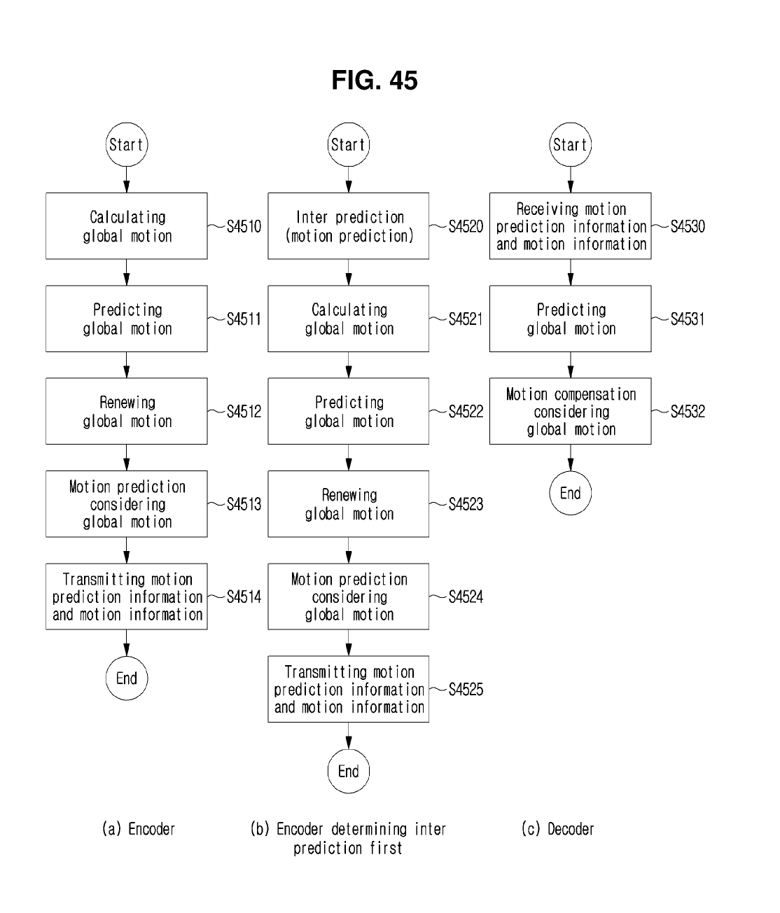

FIG. 45 shows an example of the process to which a global motion prediction method using Method 1 is applied.

Referring to FIG. 45(a), the global motion is calculated at step S4510, and the global motion may be predicted at step S4511. Based on the calculated global motion and the predicted global motion, the global motion may be refreshed at step S4512. Considering the refreshed global motion, motion prediction (or inter prediction) may be performed at step S4513. Motion prediction information and motion information may be transmitted at step S4514. Here, the motion prediction information and the motion information may be inter prediction information.

FIG. 45(a) shows an example of an encoder using the predicted and refreshed global motion without using the calculated global motion. When the same inter-prediction process is defined in the encoder and the decoder, it is unnecessary to transmit additional information.

However, when global motion prediction accuracy is low, this method may degrade motion prediction accuracy considering the global motion and may degrade encoding efficiency.

Referring to FIG. 45(b), motion prediction (or inter prediction) is performed first at step S4520, the global motion is calculated at step S4521, and global motion may be predicted at step S4522. Based on the calculated global motion and the predicted global motion, the global motion may be refreshed at step S4523. Considering the refreshed global motion, motion prediction (or inter prediction) may be performed at step S4524. Motion prediction information and motion information may be transmitted at step S4525.

FIG. 45(b) shows the encoder using the predicted and refreshed global motion like the encoder in FIG. 45(a), but performing general inter prediction first different from FIG. 45(a). When global motion information is calculated from local motion information, the method in FIG. 45(b) may be used.

Referring to FIG. 45(c), motion prediction information and motion information are received at step S4530, the global motion is predicted at step S4531, and motion compensation (or inter prediction) considering the predicted global motion may be performed at step S4532.

FIG. 45(c) is a view illustrating an example of a decoder corresponding to the cases (a) and (b). Since a global motion prediction method is determined in the same process as the encoder, it is possible to decode an image without receiving additional information.

Method 2. Transmitting the Difference Between Predicted Global Motion Information and Original Global Motion Information so as to Reduce the Amount of Information to be Transmitted (a residual transmission mode)

When the accuracy of predicted global motion information is high, the difference between predicted global motion information and the original global motion information is small. Thus, the range of the difference between the predicted global motion information and the original global motion information has the characteristic that the occurrence frequency of the sign increases as the value is close to a value indicating no difference. When using entropy coding that is a method of compressing information using characteristics in which the occurrence frequency of the sign is concentrated, the number of bits in the bitstream for representing global motion information may be reduced. Consequently, encoding efficiency may be enhanced.

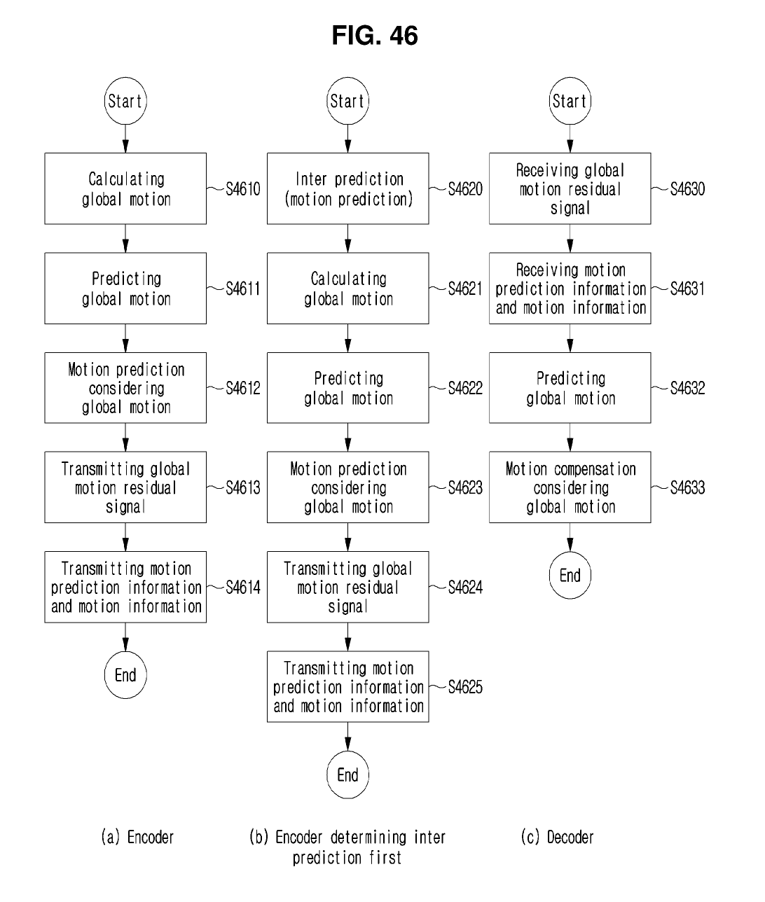

FIG. 46 shows an example of the process to which a global motion prediction method using Method 2 is applied.

Referring to FIG. 46(a), the global motion may be calculated at step S4610, and the global motion may be predicted at step S4611. Considering the calculated global motion and the predicted global motion, motion prediction (or inter prediction) may be performed at step S4612. A global motion residual signal (or global motion residual information) indicating the difference between the predicted global motion and the calculated global motion may be transmitted at step S4613. Motion prediction information and motion information may be transmitted at step S4614. Here, motion prediction information and motion information may be inter prediction information.

Referring to FIG. 46(b), motion prediction (or inter prediction) may be performed first at step S4620, the global motion may be calculated at step S4621, and the global motion may be predicted at step S4622. Considering the calculated global motion and the predicted global motion, motion prediction (or inter prediction) may be performed at step S4623. A global motion residual signal (or global motion residual information) indicating the difference between the predicted global motion and the calculated global motion may be transmitted at step S4624. Motion prediction information and motion information may be transmitted at step S4625.

FIG. 46(a) shows the encoder that, after predicting the global motion, transmits the difference between original global motion information and the predicted global motion information as a global motion residual signal. FIG. 46(b) shows the encoder that transmits the global motion residual signal like the encoder in FIG. 46(a), but performs general inter prediction first different from FIG. 46(a). The method may be used in calculating global motion information from local motion information.

Referring to FIG. 45(c), with the global motion residual signal, motion prediction information and motion information may be received at step S4630 and S4631, the global motion may be predicted at step S4632, and considering the predicted global motion, motion compensation (or inter prediction) may be performed at step S4633.

FIG. 46(c) shows an example of a decoder that may be used in the cases of FIGS. 46(a) and 46(b). The global motion prediction method is determined in the same process as the encoder. In this process, the global motion residual signal may be received to reconstruct global motion information, and it may be used to decode an image. When transmitting and receiving the global motion residual signal, the global motion information may be reconstructed to be the same as the original such that accuracy of motion prediction considering global motion may be maintained at a high level. However, additional information, i.e., the global motion residual signal, is included in the bitstream, and thus encoding efficiency may be degraded.

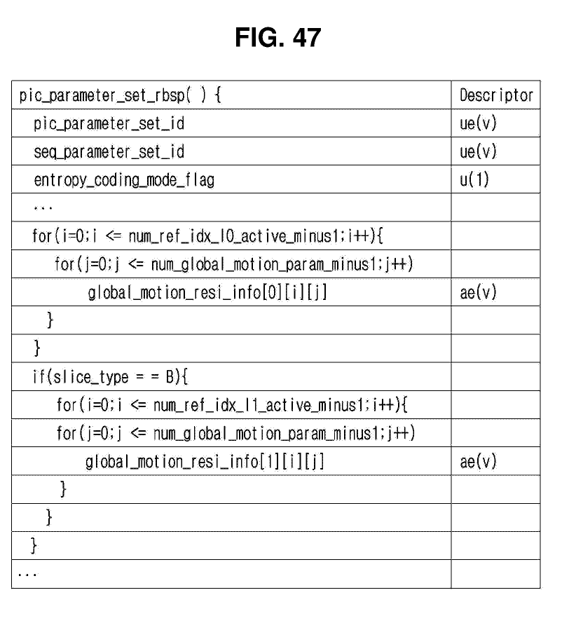

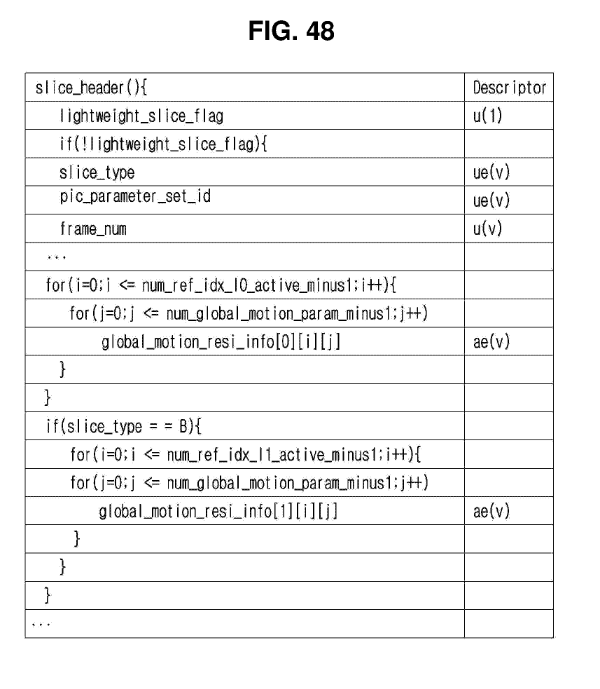

FIGS. 47 and 48 are views illustrating examples of a syntax of HEVC (High Efficiency Video Coding) to which a method of transmitting and receiving a global motion residual signal is applied.

FIG. 47 is an example applied to PPS (Picture Parameter Set), and FIG. 48 is an example applied to a slice header syntax.

In the two figures, num_global_motion_param_minus1 is a value indicating how many parameters are used for residual global motion information representing the global motion, may be represented by a value of (the number of parameters of the residual global motion information) −1.

num_ref_idx_10_active_minus1 is a variable indicating how many reference pictures exist in the L0 reference picture list, and has a value of (the number of reference pictures in the L0 list) −1. num_ref_idx_11_active_minus1 is a variable indicating how many reference pictures exist in the L1 reference picture list, and has a value of (the number of reference pictures in the L1 list) −1.

Accordingly, a number of pieces of residual global motion information corresponding to the number of reference pictures of each reference picture list are required. For each piece of residual global motion information, a number of parameters corresponding to a value of num_global_motion_param_minus1+1 are required to be received. Each parameter is reconstructed in global_motion_resi_info.

An efficient method may be selected from Method 1 of FIG. 45 and Method 2 of FIG. 46. In this case, a signal indicating which method is selected may be required.

Also, when both Method 1 of FIG. 45 and Method 2 of FIG. 46 are either inefficient or it is impossible to use global motion prediction, original global motion information may be intactly transmitted. In this case, a signal indicating that the original global motion information is transmitted may also be required.

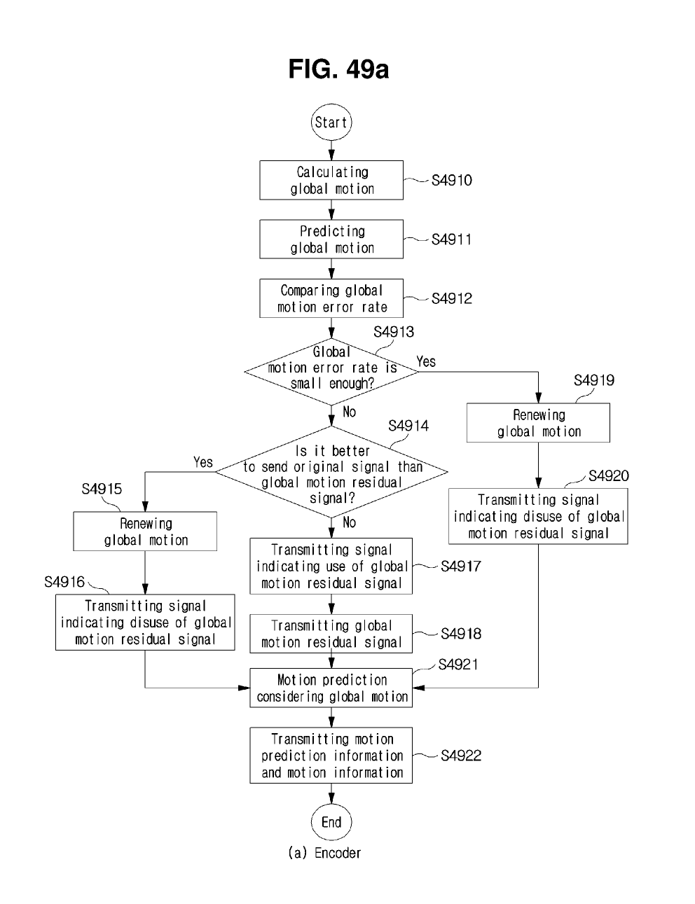

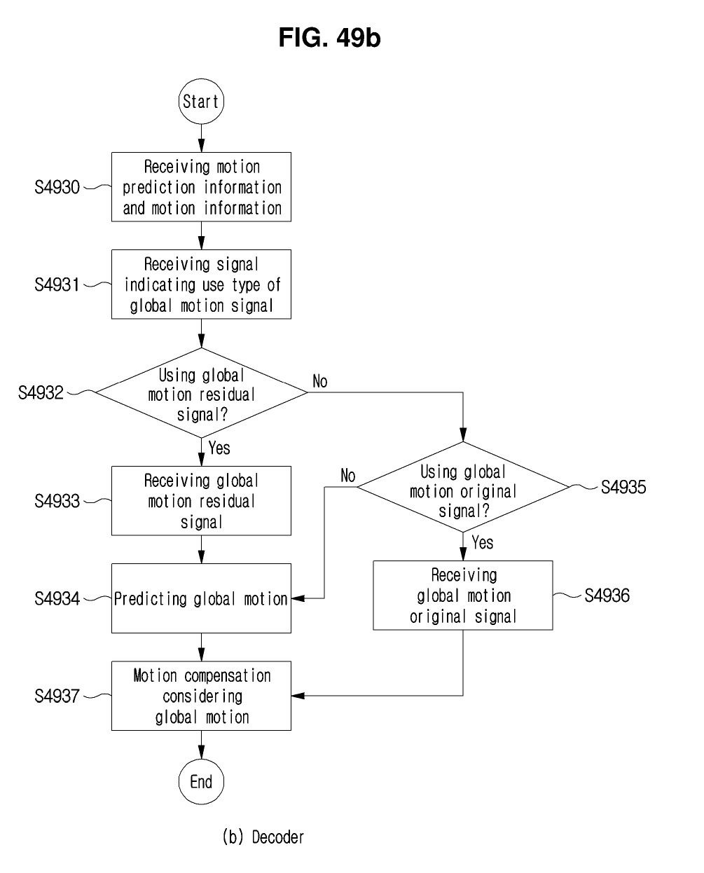

FIG. 49 is a view illustrating examples of encoding and decoding methods that select and use a method capable of obtaining optimum encoding efficiency among a method intactly using predicted global motion information without transmitting additional global motion information, a method transmitting residual global motion information, and a method transmitting original global motion information.

Referring to FIG. 49a, the global motion may be calculated at step S4910, the global motion may be predicted at step S4911, and the error rate between the predicted global motion and the calculated global motion may be compared at step S4912. When the error rate is small enough at step S4913-Yes, the global motion may be refreshed based on the calculated global motion and the predicted global motion at step S4919, and a signal indicating disuse of residual global motion information may be transmitted at step S4920. That is, the method intactly using predicted global motion information without transmitting additional global motion information may be selected.

In the meantime, when the error rate is not small enough at step S4913-No, whether transmitting residual global motion information is better that transmitting original global motion information may be determined. Here, when determining that transmitting original global motion information is better at step S4914-Yes, a signal indicating use of the original global motion information may be transmitted at step S4915, and the original global motion information may be transmitted at step S4916. That is, the method transmitting the original global motion information may be selected.

In the meantime, when determining that transmitting the original global motion information is not better at step S4914-No, a signal indicating use of the residual global motion information may be transmitted at step S4917, and the residual global motion information may be transmitted at step S4918.

Motion prediction (inter prediction) considering global motion may be performed at step S4921, and motion prediction information and motion information may be transmitted at step S4922.

Referring to FIG. 49b, the motion prediction information and motion information may be received at step S4930, and a signal indicating a use type of a global motion signal may be received at step S4931. Here, the signal indicating the use type of the global motion signal may include the signal indicating disuse of the residual global motion information, the signal indicating use of the residual global motion information, and the signal indicating use of the original global motion information, and may be global motion prediction mode information represented by index information indicating a table defined in the encoding and the decoder. For example, a table may be defined as 1: prediction skip mode, 2: residual transmission mode, and 3: residual non-transmission mode.

Based on the received signal indicating the use type of the global motion signal, whether a global motion residual signal (or residual global motion information) is used may be determined at step S4932. When determining that the global motion residual signal is used at step S4932-Yes, the global motion residual signal (or the residual global motion information) may be received to predict the global motion at step S4933 and S4934, and motion compensation considering the global motion may be performed at step S4937.

In contrast, when determining that the global motion residual signal is not used at step S4932-Yes, the global motion may be predicted and motion compensation considering predicted global motion information may be performed at step S4934 and SS4937.

In FIG. 49, the encoder transmits information indicating which method is selected from among three methods to the decoder such that inconsistency between the encoder and the decoder can be prevented.

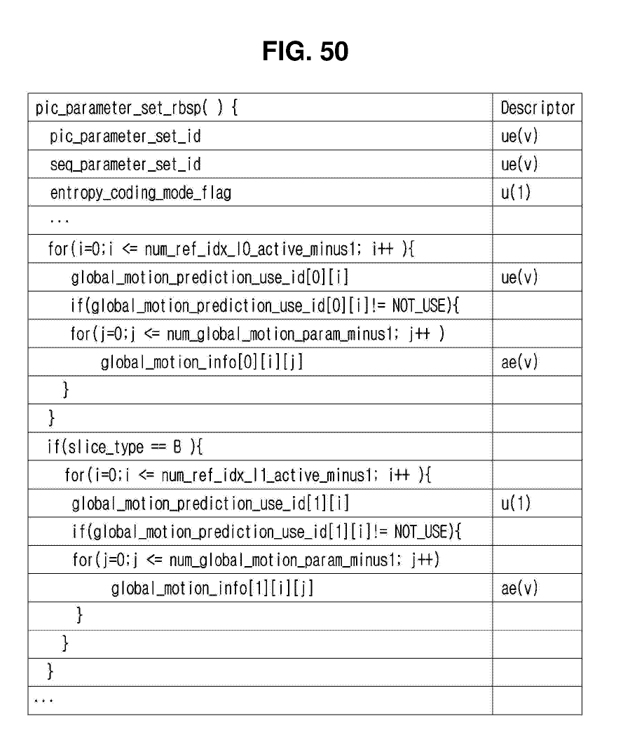

FIGS. 50, 51, and 58 are views illustrating examples where a method of selectively applying a method of transmitting and receiving a global motion signal is applied to a syntax of HEVC (High Efficiency Video Coding).

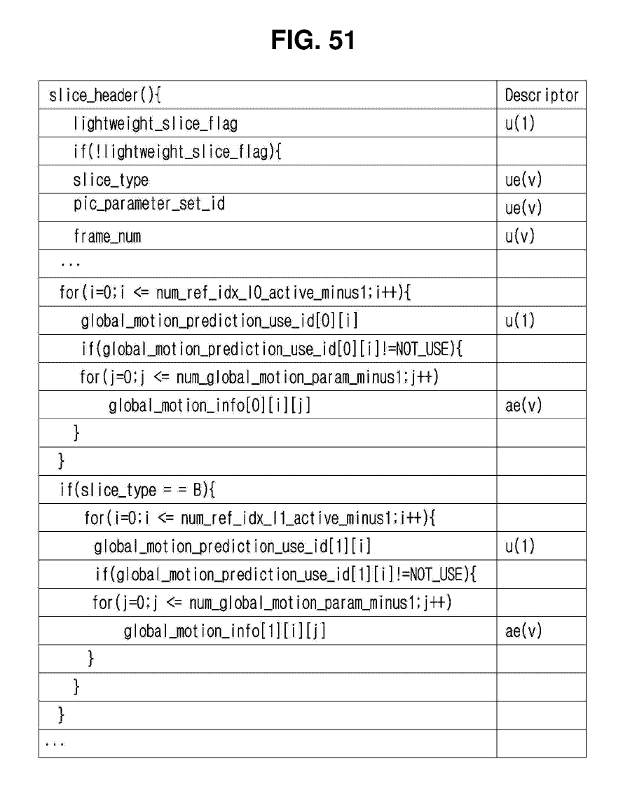

FIG. 50 is an example to which PPS (Picture Parameter Set) is applied, and FIG. 51 is an example of to which a slice header syntax is applied.

In the two figures, num_global_motion_param_minus1 is a value indicating how many parameters are used for residual global motion information representing the global motion, and may be represented by a value of (the number of parameters of the residual global motion information) −1. num_ref_idx_10_active_minus1 is a variable indicating how many reference pictures exist in the L0 reference picture list, and has a value of (the number of reference pictures in the L0 list) −1.

num_ref_idx_11_active_minus1 is a variable indicating how many reference pictures exist in the L1 reference picture list, and has a value of (the number of reference pictures in the L1 list) −1. Thus, a number of pieces of residual global motion information corresponding to the number of reference pictures of each reference picture list are required. For each piece of residual global motion information, a number of parameters corresponding to a value of num_global_motion_param_minus1+1 are required to be received.

global_motion_prediction_use_id indicates which global motion signal transmission/reception is used for each reference picture. Thus, it may be received as much as the number of reference pictures, and the method of receiving global motion information may differ depending on the value.

The range of the value may differ depending on the number of used reception methods.

In the example of FIG. 49, there are three transmission/reception methods, it may be indicated as three values. When global_motion_prediction_use_id is not NOT_USE indicating that global motion information is not received, each parameter is reconstructed in global_motion_info. Here, in the example of FIG. 49, a value being stored may differ depending on whether global_motion_prediction_use_id indicates receiving the residual global motion signal or the original global motion signal.

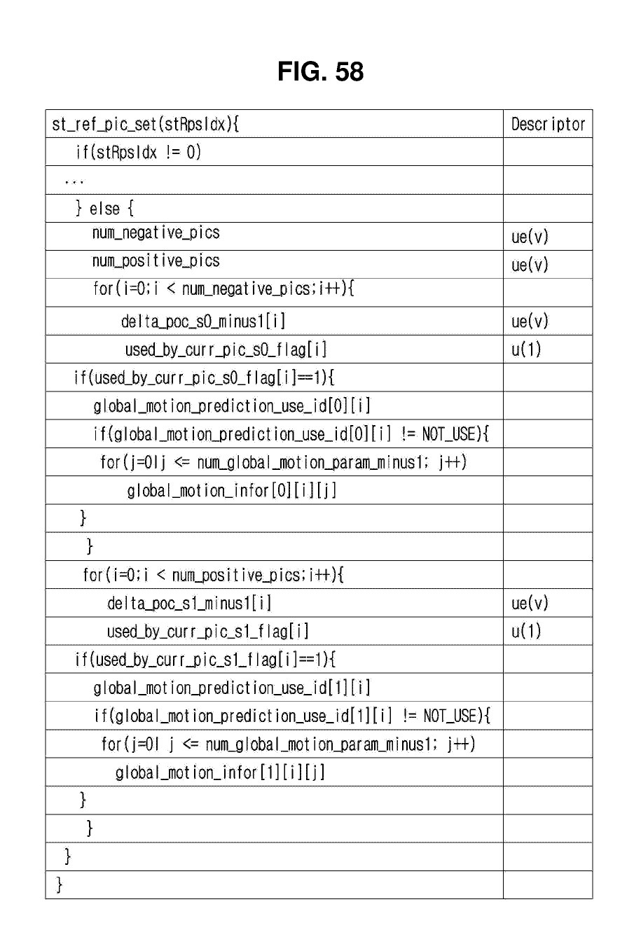

FIG. 58 shows an example applied to a short-term reference picture syntax st_ref_pic_set that may be applied to PPS (Picture Parameter Set) or a slice header syntax.

num_negative_pics means the number of reference pictures that are a temporally previous frame (i.e., having smaller POC value than that of the current frame) than the current frame. num_posituve_pics means the number of reference pictures that are a temporally subsequent frame (i.e., having larger POC value than that of the current frame) than the current frame. In delta_poc-s0_minus1 [i]+1, when i is “0”, it indicate the difference between the POC value of the current frame and the POC value of the first reference picture having smaller POC value than that of the current frame, and when i is larger than “0”, it indicates the difference between the POC values of the (i−1)-th and i-th frames having smaller POC values than that of the current frame. In Delta_poc_s1_minus1 [i]+1, when i is “0”, it indicates the difference between the POC value of the current frame and the POC value of the first reference picture having larger POC value than that of the current frame, and when i is larger than “0”, it indicates the difference the POC values of the (i−1)-th and i-th frames having larger POC values than that of the current frame. use_by_curr_pic_s0_flag[i] indicates that the i-th reference picture having a smaller POC value than that of the current frame is used as a reference picture of the current frame. use_by_curr_pic_s1_flag[i] indicates that the i-th reference picture having a larger POC value than that of the current frame is used as a reference picture of the current frame. The remaining syntax is as described above. Since the L0 reference picture list and the L1 reference picture list are configured using pictures having a use_by_curr_pic_s0_flag value of “1” or a use_by_curr_pics1_flag value of “1” transmitted in FIG. 58, a number of pieces of residual global motion information corresponding to the number of reference pictures having the use_by_curr_pic_s0_flag value of “1” or the use_by_curr_pic_s1_flag value of “1” are required. For each piece of residual global motion information, a number of parameters corresponding to a value of num_global_motion_param_minus1+1 are required to be received.

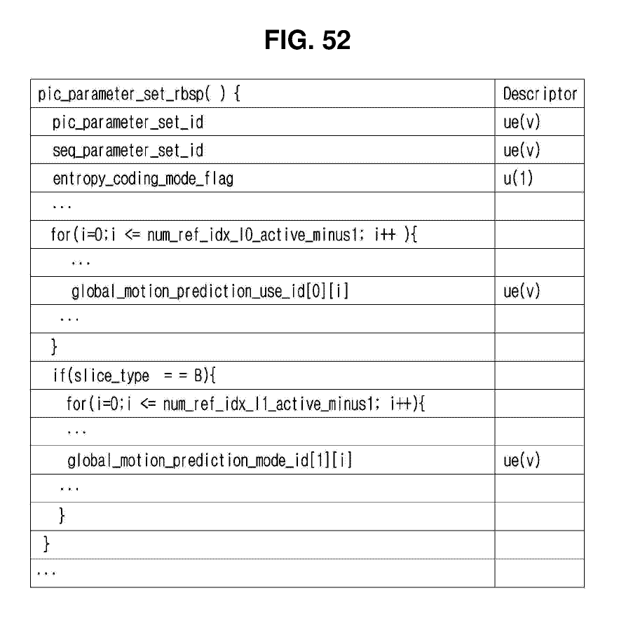

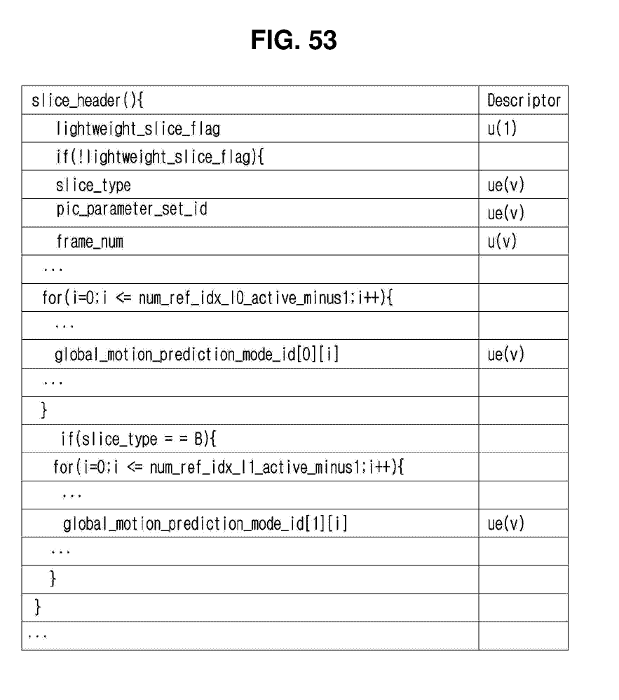

FIGS. 52, 53, and 59 are views illustrating examples where a method of selectively applying a global motion prediction method is applied to a syntax of HEVC (High Efficiency Video Coding). FIG. 52 is an example applied to PPS (Picture Parameter Set), and FIG. 53 is an example applied to a slice header syntax. In the two figures, num_ref_idx_10_active_minus1 is a variable indicating how many reference pictures exist in the L0 reference picture list, and has a value of (the number of reference pictures in the L0 list) −1. num_ref_idx_11_active_minus1 is a variable indicating how many reference pictures exist in the L1 reference picture list, and has a value of (the number of reference pictures in the L1 list) −1. Thus, a number of pieces of global motion prediction method selection information corresponding to the number of reference pictures of each reference picture list are required. global_motion_prediction_mode_id indicates which global motion prediction method is used for each reference picture.

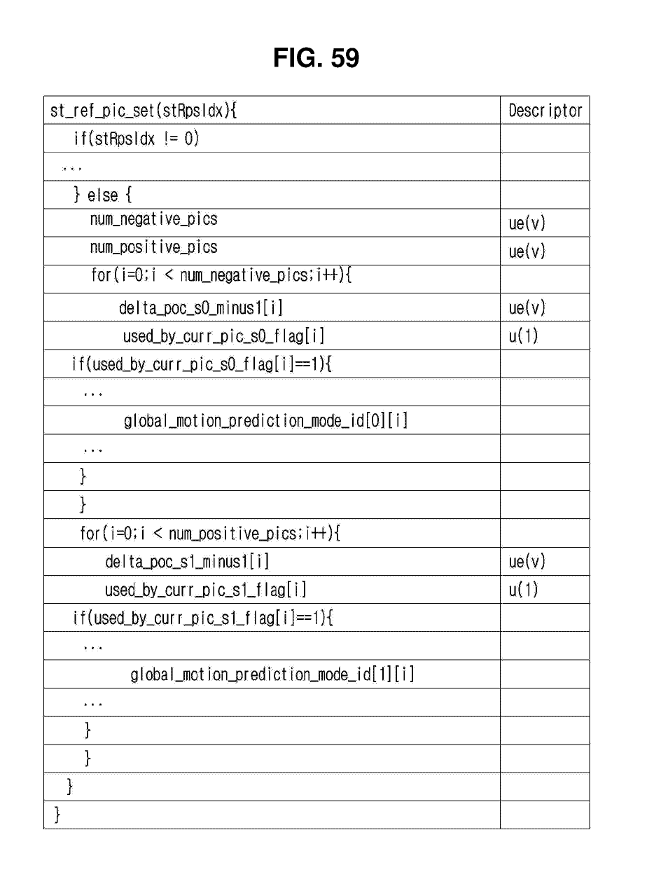

Thus, it may be received as much as the number of reference pictures, and the method of predicting global motion information may differ depending on the value. The range of the value may differ depending on the number of used global motion prediction methods. This information enables the prediction method determination structure of the encoder to correspond to that of the decoder, and may be omitted. FIG. 59 shows an example applied to a short-term reference picture syntax st_ref_pic_set that may be applied to PPS (Picture Parameter Set) or a slice header syntax. Since the L0 reference picture list and the L1 reference picture list are configured using pictures having a use_by_curr_pic_s0_flag value of “1” or a use_by_curr_pic_s1_flag value of “1” transmitted in FIG. 59, a number of pieces of global motion prediction method selection information corresponding to the number of reference pictures having the use_by_curr_pic_s0_flag value of “1” or the use_by_curr_pic_s1_flag value of are required. global_motion_prediction_mode_id indicates which global motion prediction method is used for each reference picture. Thus, it may be received as much as the number of reference pictures, and the method of predicting global motion information may differ depending on the value.

In the meantime, when the global motion is predicted, the encoder and the decoder are required to perform the same process so as to prevent inconsistency between the encoder and the decoder.

Therefore, the encoder is required to perform an encoding or decoding process by using global motion information reconstructed through the prediction process rather than original global motion information.

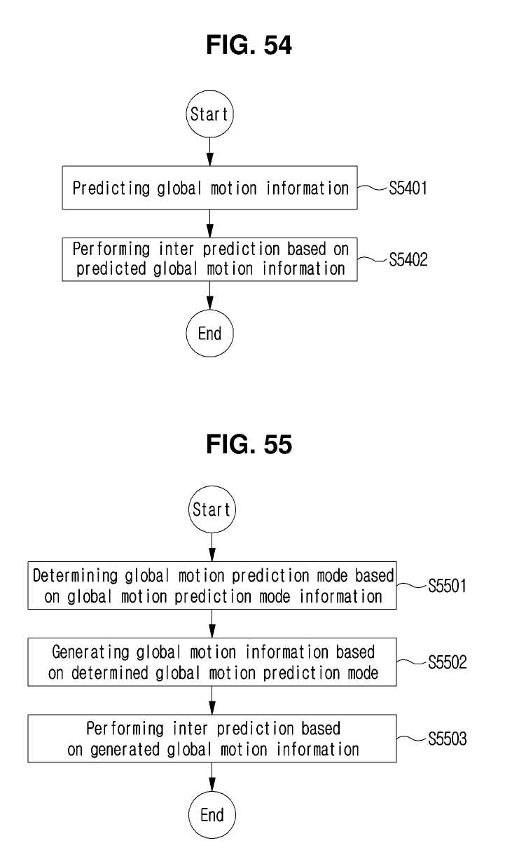

FIG. 54 is a flowchart illustrating a method for decoding an image according to an embodiment of the present invention.

Referring to FIG. 54, global motion information may be predicted at step S5401, and inter prediction may be performed based on the predicted global motion information at step S5402. Here, the global motion information may be represented by any one of a two-dimensional vector, a geometric transform matrix, a rotation angle, and a magnification ratio.

According to an embodiment of predicting the global motion information at step S5401, global motion information may be predicted based on global motion information for at least one neighbor reference picture in a reference picture list and POC (Picture Of Count) interval of at least one neighbor reference picture and a current picture. Since a detailed description thereof has been described in FIGS. 18 to 20, and 27, it will be omitted.

According to another embodiment of predicting the global motion information at step S5401, global motion information may be predicted based on multiple pieces of local motion information. Since a detailed description thereof has been described in FIGS. 21 to 26, it will be omitted.

According to still another embodiment of predicting the global motion information at step S5401, global motion information may be predicted using an average of multiple pieces of local motion information.

According to still another embodiment of predicting the global motion information at step S5401, global motion information may be predicted by interpolating global motion information of at least one neighbor reference picture. Since a detailed description thereof has been described in FIG. 29, it will be omitted.

According to still another embodiment of predicting the global motion information at step S5401, when the global motion information is represented by a geometric transform matrix, the global motion information may be predicted based on matrix multiplication of global motion information of at least one neighbor reference picture, or the global motion information may be predicted using a unit matrix. Since a detailed description thereof has been described in FIGS. 35 to 41, it will be omitted.

In the meantime, in global motion information for a multi-channel image, global motion information for one channel component may be predicted based on global motion information of another channel. For example, global motion information for a chroma component may be predicted based on global motion information for a luma component.

FIG. 55 is a flowchart illustrating a method for decoding an image according to an embodiment of the present invention.

Referring to FIG. 55, a global motion prediction mode may be determined based on global motion prediction mode information at step S5501, and global motion information may be generated based on the determined global motion prediction mode at step S5502. Inter prediction may be performed based on the generated global motion information at step S5503. Here, the global motion prediction mode may include a prediction skip mode, a residual transmission mode, and a residual non-transmission mode.

Specifically, when the global motion prediction mode is the prediction skip mode, the global motion information may be obtained from the bitstream. When the global motion prediction mode is the residual transmission mode, the global motion may be generated using the residual global motion information obtained from the bitstream and the predicted global motion information. When the global motion prediction mode is the residual non-transmission mode, the global motion may be generated using the predicted global motion information. Since a detailed description thereof has been described in FIG. 49, it will be omitted.

In the meantime, in the method for decoding an image, determining of the global motion prediction mode based on the global motion prediction mode information at step S5501 may be omitted. In this case, global motion information may be generated based on a pre-determined global motion prediction mode.

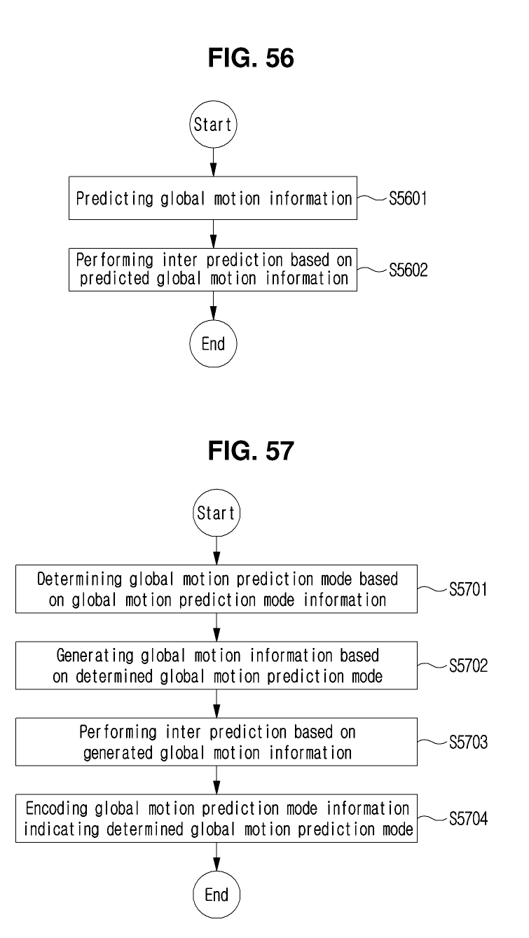

FIG. 56 is a flowchart illustrating a method for encoding an image according to an embodiment of the present invention.

Referring to FIG. 56, global motion information may be predicted at step S5601, and inter prediction may be performed based on the predicted global motion information at step S5602. Here, the global motion information may be represented by any one of a two-dimensional vector, a geometric transform matrix, a rotation angle, and a magnification ratio.

According to an embodiment of predicting the global motion information at step S5601, global motion information may be predicted based on global motion information for at least one neighbor reference picture in a reference picture list and POC (Picture Of Count) interval of at least one neighbor reference picture and a current picture. Since a detailed description thereof has been described in FIGS. 18 to 20, and 27, it will be omitted.

According to another embodiment of predicting the global motion information at step S5601, the global motion information may be predicted based on multiple pieces of local motion information. Since a detailed description thereof has been described in FIGS. 21 to 26, it will be omitted.

According to still another embodiment of predicting the global motion information at step S5601, global motion information may be predicted using an average of multiple pieces of local motion information.

According to still another embodiment of predicting the global motion information at step S5601, global motion information may be predicted interpolating global motion information of at least one neighbor reference picture. Since a detailed description thereof has been described in FIG. 29, it will be omitted.

According to still another embodiment of predicting the global motion information at step S5601, when the global motion information is represented by a geometric transform matrix, global motion information may be predicted based on matrix multiplication of global motion information of at least one neighbor reference picture, or the global motion information may be predicted using a unit matrix. Since a detailed description thereof has been described in FIGS. 35 to 41, it will be omitted.

In the meantime, in global motion information for a multi-channel image, global motion information for one channel component may be predicted based on global motion information of another channel. For example, global motion information for a chroma component may be predicted based on global motion information for a luma component.

FIG. 57 is a flowchart illustrating a method for encoding an image according to an embodiment of the present invention.

Referring to FIG. 57, a global motion prediction mode may be determined at step S5701, and global motion information may be generated based on the determined global motion prediction mode at step S5702. Inter prediction may be performed based on the generated global motion information at step S5703, and global motion prediction mode information indicating the determined global motion prediction mode may be encoded at step S5704. Here, the global motion prediction mode may include a prediction skip mode, a residual transmission mode, and a residual non-transmission mode.

In the meantime, in the method for encoding an image, determining of the global motion prediction mode at step S5701 may be omitted. In this case, the global motion information may be generated based on a pre-determined global motion prediction mode.

In the meantime, a recording medium according to the present invention may store a bitstream generated by a method for encoding an image, the method including: predicting a global motion information; and performing inter prediction based on the predicted global motion information, wherein the global motion information is represented by any one of a two-dimensional vector, a geometric transform matrix, a rotation angle, and a magnification ratio.

In the meantime, the recording medium according to the present invention may store the bitstream generated by the method for encoding an image described in FIGS. 56 and 57.

The above embodiments may be performed in the same method in an encoder and a decoder.

A sequence of applying to above embodiment may be different between an encoder and a decoder, or the sequence applying to above embodiment may be the same in the encoder and the decoder.

The above embodiment may be performed on each luma signal and chroma signal, or the above embodiment may be identically performed on luma and chroma signals.

A block form to which the above embodiments of the present invention are applied may have a square form or a non-square form.

The above embodiment of the present invention may be applied depending on a size of at least one of a coding block, a prediction block, a transform block, a block, a current block, a coding unit, a prediction unit, a transform unit, a unit, and a current unit. Herein, the size may be defined as a minimum size or maximum size or both so that the above embodiments are applied, or may be defined as a fixed size to which the above embodiment is applied. In addition, in the above embodiments, a first embodiment may be applied to a first size, and a second embodiment may be applied to a second size. In other words, the above embodiments may be applied in combination depending on a size. In addition, the above embodiments may be applied when a size is equal to or greater that a minimum size and equal to or smaller than a maximum size. In other words, the above embodiments may be applied when a block size is included within a certain range.

For example, the above embodiments may be applied when a size of current block is 8×8 or greater. For example, the above embodiments may be applied when a size of current block is 4×4 or greater. For example, the above embodiments may be applied when a size of current block is 16×16 or greater. For example, the above embodiments may be applied when a size of current block is equal to or greater than 16×16 and equal to or smaller than 64×64.

The above embodiments of the present invention may be applied depending on a temporal layer. In order to identify a temporal layer to which the above embodiments may be applied may be signaled, and the above embodiments may be applied to a specified temporal layer identified by the corresponding identifier. Herein, the identifier may be defined as the lowest layer or the highest layer or both to which the above embodiment may be applied, or may be defined to indicate a specific layer to which the embodiment is applied. In addition, a fixed temporal layer to which the embodiment is applied may be defined.

For example, the above embodiments may be applied when a temporal layer of a current image is the lowest layer. For example, the above embodiments may be applied when a temporal layer identifier of a current image is 1. For example, the above embodiments may be applied when a temporal layer of a current image is the highest layer.

A slice type to which the above embodiments of the present invention are applied may be defined, and the above embodiments may be applied depending on the corresponding slice type.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments include various aspects of examples. All possible combinations for various aspects may not be described, but those skilled in the art will be able to recognize different combinations. Accordingly, the present invention may include all replacements, modifications, and changes within the scope of the claims.

The embodiments of the present invention may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field. Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in an apparatus for encoding/decoding an image.

1. A method for decoding an image, the method comprising:
predicting global motion information; and
performing inter prediction based on the predicted global motion information,
wherein the global motion information is represented by any one of a two-dimensional vector, a geometric transform matrix, a rotation angle, and a magnification ratio.

2. The method of claim 1, wherein at the predicting of the global motion information, the global motion information is predicted based on global motion information for at least one neighbor reference picture in a reference picture list and a POC (Picture Of Count) interval of the at least one neighbor reference picture and a current picture.

3. The method of claim 1, wherein at the predicting of the global motion information, the global motion information is predicted based on multiple pieces of local motion information.

4. The method of claim 3, wherein at the predicting of the global motion information, the global motion information is predicted using an average of the multiple pieces of local motion information.

5. The method of claim 1, wherein at the predicting of the global motion information, the global motion information is predicted interpolating global motion information of at least one neighbor reference picture.

6. The method of claim 1, wherein at the predicting of the global motion information, when the global motion information is represented by the geometric transform matrix, the global motion information is predicted based on matrix multiplication of global motion information of at least one neighbor reference picture.

7. The method of claim 1, wherein at the predicting of the global motion information, when the global motion information is represented by the geometric transform matrix, the global motion information is predicted using a unit matrix.

8. The method of claim 1, wherein in global motion information for a multi-channel image, global motion information for one channel is predicted based on global motion information of another channel.

9. The method of claim 8, wherein global motion information for a chroma component is predicted based on global motion information for a luma component.

10. A method for decoding an image, the method comprising:
determining a global motion prediction mode based on global motion prediction mode information;
generating global motion information based on the determined global motion prediction mode; and
performing inter prediction based on the generated global motion information,
wherein the global motion prediction mode includes a prediction skip mode, a residual transmission mode, and a residual non-transmission mode.

11. The method of claim 10, wherein at the generating of the global motion information,
when the global motion prediction mode is the prediction skip mode, the global motion information is obtained from a bitstream,
when the global motion prediction mode is the residual transmission mode, a global motion is generated using residual global motion information obtained from the bitstream and predicted global motion information, and
when the global motion prediction mode is the residual non-transmission mode, the global motion is generated using the predicted global motion information.

12. A method for encoding an image, the method comprising:
predicting global motion information; and
performing inter prediction based on the predicted global motion information,
wherein the global motion information is represented by any one of a two-dimensional vector, a geometric transform matrix, a rotation angle, and a magnification ratio.

13. The method of claim 12, wherein at the predicting of the global motion information, the global motion information is predicted based on global motion information for at least one neighbor reference picture in a reference picture list and a POC (Picture Of Count) interval of the at least one neighbor reference picture and a current picture.

14. The method of claim 12, wherein at the predicting of the global motion information, the global motion information is predicted based on multiple pieces of local motion information.

15. The method of claim 14, wherein at the predicting of the global motion information, the global motion information is predicted using an average of the multiple pieces of local motion information.

16. The method of claim 12, wherein at the predicting of the global motion information, the global motion information is predicted interpolating global motion information of at least one neighbor reference picture.

17. The method of claim 12, wherein at the predicting of the global motion information, when the global motion information is represented by the geometric transform matrix, the global motion information is predicted based on matrix multiplication of global motion information of at least one neighbor reference picture.

18. The method of claim 12, wherein in global motion information for a multi-channel image, global motion information for one channel is predicted based on global motion information of another channel.

19. A method for encoding an image, the method comprising:
determining a global motion prediction mode;
generating global motion information based on the determined global motion prediction mode;
performing inter prediction based on the generated global motion information; and
encoding global motion prediction mode information indicating the determined global motion prediction mode,
wherein the global motion prediction mode includes a prediction skip mode, a residual transmission mode, and a prediction mode.

20. A recording medium storing a bitstream formed by a method for encoding an image, the method including:
predicting global motion information; and
performing inter prediction based on the predicted global motion information,
wherein the global motion information is represented by any one of a two-dimensional vector, a geometric transform matrix, a rotation angle, and a magnification ratio.
